(19) United States
(12) Patent Application Publication
(10) Pub. No.: US 2019/0236634 A1
(43) Pub. Date: Aug. 1, 2019

(54) INFORMATION PROCESSING SYSTEM, TERMINAL APPARATUS, AND INFORMATION PROCESSING METHOD

(71) Applicants: Fumio YOSHIZAWA, Kanagawa (JP); Yoshiroh SOMEYA, Kanagawa (JP)

(72) Inventors: Fumio YOSHIZAWA, Kanagawa (JP); Yoshiroh SOMEYA, Kanagawa (JP)

(73) Assignee: Ricoh Company, Ltd., Tokyo (JP)

(21) Appl. No.: 16/251,662

(22) Filed: Jan. 18, 2019

(30) Foreign Application Priority Data
Jan. 31, 2018 (JP) 2018-015943
Nov. 6, 2018 (JP) 2018-209106

(51) Int. Cl. G06Q 30/02

(52) U.S. Cl. CPC G06Q 30/0217; G06Q 30/0238; G06Q 30/0282

(57) ABSTRACT

An information processing system controls usage rights relating to food provided at a facility, and includes an information processing apparatus and a terminal, and executes a process including storing the usage rights corresponding to the terminal apparatus; determining whether the terminal apparatus is located in the facility, based on identification information included in a signal output in the facility; enabling usage. of a usage right relating to the food provided at the facility, among the usage rights corresponding to the terminal apparatus, when the terminal apparatus is located in the facility;
displaying, on the terminal apparatus, an input screen requesting input of predetermined information relating to the food corresponding to a first usage right among the usage rights usable in the facility, after using the first usage right; and determining whether to validate a usage right other than the first usage right according to whether the predetermined information is input.

### CROSS-REFERENCE TO RELATED APPLICATION

The present application is based on and claims priority under 35 U.S.C. § 119 to Japanese Patent Application No. 2018-015943, filed on Jan. 31, 2018 and Japanese Patent Application No. 2018-209106, filed on Nov. 6, 2018, the contents of which are incorporated herein by reference in their entirety.

### BACKGROUND OF THE INVENTION

### 1. Field of the Invention

The present invention relates to an information processing system, a terminal apparatus, and an information processing method.

### 2. Description of the Related Art

There is a known system in which a customer, who has visited a store providing food and drinks, evaluates the food and drinks that the customer has eaten and drunken, evaluates the store that has provided the food and drinks, or evaluates the service provided by the store, etc., and these evaluation results are disclosed on the Internet, etc.

For example, there is known a store information providing system capable of improving the accuracy of the evaluation result with respect to a predetermined product, and facilitating the operation of searching for a product that matches the needs of the searching user, by using an individual review with respect to the predetermined product posted by the user (see, for example, Patent Document 1).

Patent Document 1: Japanese Unexamined Patent Application Publication No. 2013-73577

### SUMMARY OF THE INVENTION

An aspect of the present invention provides an information processing system, a terminal apparatus, and an information processing method in which one or more of the disadvantages of the related art are reduced.

According to one aspect of the present invention, there is provided an information processing system for controlling one or more usage rights relating to food or a service provided at a facility, the information processing system including an information processing apparatus and a terminal apparatus configured to communicate with the information processing apparatus, the information processing system including at least one processor, in communication with at least one memory, executing a process including storing information of the one or more usage rights corresponding to the terminal apparatus; determining whether the terminal apparatus is located in the facility, based on identification information included in a signal output in the facility; enabling usage of the one or more usage rights relating to the food or the service provided at the facility, among the one or more usage rights corresponding to the terminal apparatus, in response to determining that the terminal apparatus is located in the facility; displaying, on the terminal apparatus, an input screen requesting input of predetermined information relating to the food or the service corresponding to a first usage right among the one or more usage rights usable in the facility, after the first usage right is used; and determining whether to validate a usage right other than the first usage right among the one or more usage rights, in the terminal apparatus, according to whether the predetermined information is input to the input screen.

### BRIEF DESCRIPTION OF THE DRAWINGS

FIG. 1 is a diagram illustrating an example of a system configuration of an information processing system according to an embodiment of the present invention;

FIG. 2 is a diagram illustrating an example of a hardware configuration of a management server according to an embodiment of the present invention;

FIG. 3 is a diagram illustrating an example of a hardware configuration of an information terminal according to an embodiment of the present invention;

FIG. 4 is a diagram illustrating an example of a functional configuration of the management server and the information terminal according to an embodiment of the present invention;

FIG. 5 is a diagram (1) illustrating an example of information stored by the management server according to an embodiment of the present invention;

FIGS. 6A and 6B are diagrams (2) illustrating an example of information stored by the management server according to an embodiment of the present invention;

FIG. 7 is a sequence diagram illustrating an example of an activation process and a store entering process according to a first embodiment of the present invention;

FIGS. 8A to 8F are diagrams illustrating examples of a display screen of the information terminal according to the first embodiment of the present invention;

FIG. 9 is a flowchart illustrating an example of a coupon usage process according to the first embodiment of the present invention;

FIG. 10 is a sequence diagram illustrating an example of a coupon usage process according to the first embodiment of the present invention;

FIG. 11 is a sequence diagram illustrating an example of a coupon usage process according to a second embodiment of the present invention;

FIG. 12 is a diagram illustrating an example of a functional configuration of a management server and an information terminal according to a third embodiment of the present invention;

FIG. 13 is a sequence diagram illustrating an example of an activation process and a store entering process according to the third embodiment of the present invention; and

FIGS. 14A to 14F are diagrams illustrating an example of a display screen of an application according to an embodiment.

### DETAILED DESCRIPTION OF THE PREFERRED EMBODIMENTS

For example, there are many so-called “first-time customers”, among users using the service provided by the system as described in Patent Document 1, and in many cases, it is not possible to obtain evaluation results that are as reliable as those of repeaters (such as regular customers), or it is not possible to obtain evaluation results periodically, or it is not possible to obtain a stable number of evaluation results.

Furthermore, with respect to a questionnaire prepared by a facility, it is possible for the facility user to respond irresponsibly depending on his/her mood, and, therefore, it has been difficult to use such response results as information for developing services and menus to which the users' preferences are applied.

It has been desired to develop contents that can motivate facility users, such as first-time customers and repeaters, to use the facility more often, and to develop a system that enables the collection of more reliable evaluation results with respect to services and menus of the facility. However, due to the above difficulties, the system as described in Patent Document 1 only contributes to the improvement of the accuracy of searching for products, and, therefore, it has not been possible to realize the desired contents or system.

An embodiment of the present invention provides an information processing system that controls the usage rights with respect to food and drinks or services provided at facilities. Accordingly, the present invention has made it possible to solve the problems of the related art described above.

Embodiments of the present invention will be described by referring to the accompanying drawings.

### <System Configuration>

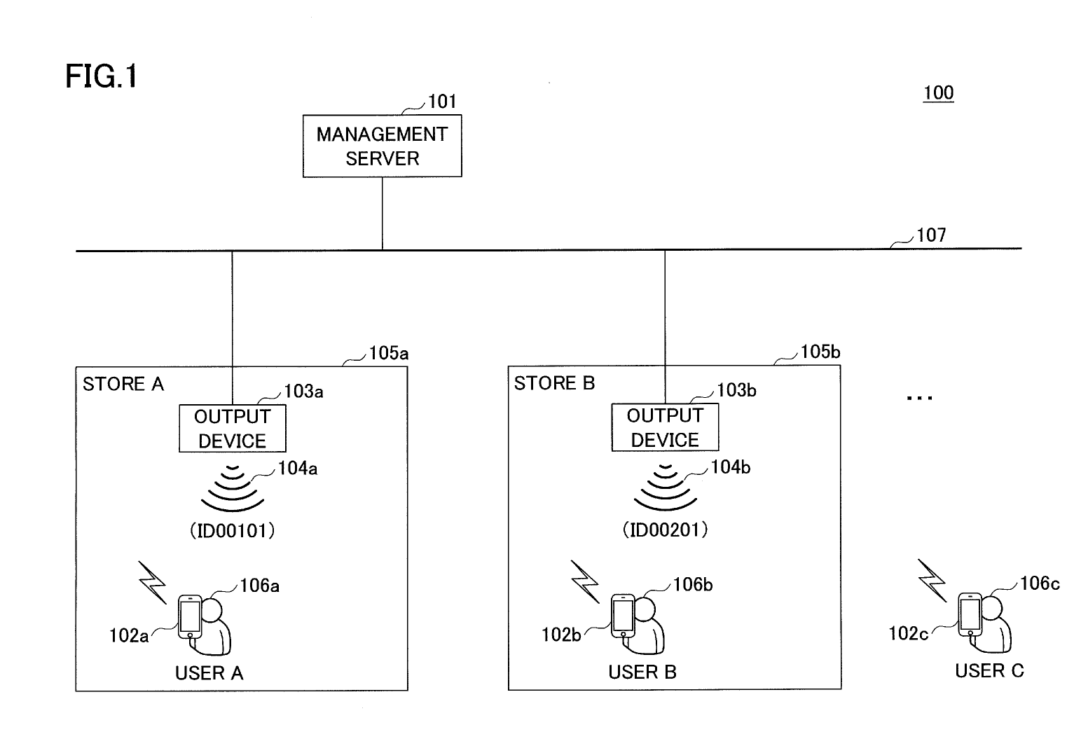

FIG. 1 is a diagram illustrating an example of a system configuration of an information processing system according to an embodiment. An information processing system 100 includes, for example, a management server 101, one or more information terminals 102a, 102b, 102c, . . . capable of communicating with the management server 101, and one or more output devices 103a, 103b, . . . installed in a facility such as a store, etc.

Note that in the following description, “information terminal 102” is used to indicate any information terminal among one or more of the information terminals 102a, 102b, 102c, . . . Furthermore, “output device 103” is used to indicate any output device among one or more of the output devices 103a, 103b, . . .

The management server (information processing apparatus) 101 is, for example, an information processing apparatus such as a Personal Computer (PC), etc., or a system including a plurality of information processing apparatuses, connected to a network 107 such as the Internet. The management server 101 stores information on usage rights (usage privileges) with respect to food and drinks and services, etc., provided at a facility such as a store A 105a and a store B 105b, and information on facilities such as the store A 105a and the store B 105b.

Usage rights with respect to food and drinks and services provided at facilities include, for example, electronic coupons, electronic tickets, and electronic discount tickets, etc., for using food and drinks and services at discounted prices at the facilities. Here, as a matter of ease of explanation, the following explanation will be made assuming that the usage right is an “electronic coupon”, and that the food and drinks and services, etc., provided at a facility are “food”; however, the scope of the present invention is not limited as such.

In response to a request from the information terminal 102, the management server 101 provides information on an electronic coupon (usage right) corresponding to the information terminal 102, and information on the aforementioned facility, etc. Furthermore, the management server 101 collects, from the information terminal 102, evaluation information (for example, comments, evaluation points, and information on good or bad, etc.) regarding food corresponding to electronic coupons used at the information terminal 102, and stores the collected information.

The output device 103 is a device that outputs signals including identification information corresponding to each facility, in a facility such as the store A 105a or the store B 105b, etc., that provides food, etc., corresponding to the electronic coupon.

For example, in FIG. 1, the output device 103a is installed indoors in the store A 105a and outputs a sound wave 104a including signal identification information (hereinafter referred to as a sound wave ID) “ID00101” for identifying a sound wave, in the store A 105a. Similarly, the output device 103b is installed indoors in the store B 105b and outputs a sound wave 104b including a sound wave ID “ID00201” in the store B 105b. Note that the number of the output devices 103 installed in each facility may be any number of one or more.

As another example, the signal output by the output device 103 may be radio waves of short-distance wireless communication such as Bluetooth (registered trademark). Low Energy (hereinafter referred to as BLE), for example. Here, the following explanation will be made assuming that the signals output from the output device 103 are sound waves.

Preferably, the output device 103 outputs sound waves including a sound wave ID within a high frequency range of, for example, 16 kHz or more, in a frequency range (approximately 20 Hz to 24 kHz) that can be acquired by the information terminal 102. Sound waves are preferable for transmitting information such as a sound wave ID, because sound waves with higher frequencies are more directive, and sound waves with a frequency of 16 kHz or more can be hardly heard by humans.

Preferably, the output device 103 is capable of communicating with the management server 101 via the network 107, and outputs sound waves including the sound wave ID instructed from the management server 101 into the store. Furthermore, the management server 101 stores facility information associating identification information (hereinafter referred to as a store ID) for identifying a store with a sound wave ID included in sound waves output in the store.

The information terminal (terminal apparatus) 102 is an information processing device such as a smartphone, a mobile phone, a tablet terminal, and a wearable terminal, etc., possessed by a user using a service provided by the information processing system 100. The information terminal 102 can be connected to the network 107 by wireless communication such as a wireless Local Area Network (LAN) or Long Term Evolution (LTE), etc., and can communicate with other devices such as the management server 101.

The information terminal 102 executes an application program (hereinafter referred to as an application) for the information terminal 102 compatible with the information processing system 100, thereby acquiring, from the management server 101, usage right information that is information of an electronic coupon corresponding to the information terminal 102.

Furthermore, for example, when entering the store A 105a, the information terminal 102 acquires the sound wave ID included in the sound waves output from the output device 103a, and transmits the acquired sound wave ID and terminal identification information (hereinafter referred to as “application ID”) for identifying the information terminal 102, to the management server 101.

Here, the application ID is identification information unique to each of the information terminals 102 generated by an application, when an application corresponding to the information processing system 100 is installed in the information terminal 102, and the application ID is an example of terminal identification information for identifying the information terminal 102. By using the application ID, the information processing system 100 can identify the information terminal 102 without depending on personal information such as a telephone number or an e-mail address, for example.

The application ID is a preferable example of the terminal identification information for identifying the information terminal 102; however, for example, the application ID may identification information of the information terminal 102 or the user (for example, a telephone number, an employee ID, or an e-mail address, etc.).

Upon receiving the application ID and the sound wave ID from the information terminal 102, the management server 101 uses facility information associating the sound wave ID and the store ID described above, to determine whether the information terminal 102 is within any of the stores. For example, when the sound wave ID received from the information terminal 102 is stored in the facility information, the management server 101 can determine that the information terminal 102 is within the store of the store ID corresponding to the sound wave ID.

Furthermore, when the management server 101 determines that the information terminal 102 is within the store of the store ID corresponding to the sound wave ID, the management server 101 transmits information on the store of the store ID corresponding to the sound wave ID, to the information terminal 102. Thus, for example, the information terminal 102a in FIG. 1 can recognize that the information terminal 102a is in the store A 105a by using the store information reported from the management server 101.

As another example, the information terminal 102 may acquire the facility information in advance from the management server 101 and store the facility information in a storage unit, for example, when the application is activated. In this case, the information terminal 102 can acquire store information corresponding to the acquired sound wave ID by using the facility information stored in the storage unit.

When the information terminal 102 is in the store A 105a, the information terminal 102 uses the usage right information acquired from the management server 101 to enable the usage of an electronic coupon for food, etc., provided at the store A 105a (making this electronic coupon available for usage), among the electronic coupons corresponding to the information terminal 102.

Furthermore, when the electronic coupon usable within the store A 105a is used, the information terminal 102 displays, on a display unit of the information terminal 102, an evaluation information input screen requesting input of evaluation information regarding the food, etc., corresponding to the used electronic coupon.

Furthermore, the information terminal 102 controls whether an electronic coupon, which is an electronic coupon other than the used electronic coupon, is to be validated (to be made available for usage) in the information terminal 102, according to the presence or absence of input of evaluation information to the evaluation information input screen.

For example, when the evaluation information has not been input to the evaluation information input screen, the information terminal 102 invalidates an electronic coupon (makes the electronic coupon unavailable for usage) other than the used electronic coupon, among the electronic coupons corresponding to the information terminal 102. For example, control is implemented such that the invalidated electronic coupon cannot be selected in the menu screen of the application displayed on the display unit of the information terminal 102, and the user cannot select a next electronic coupon.

On the other hand, when the evaluation information is input to the evaluation information input screen on the information terminal 102, the information terminal 102 validates an electronic coupon other than the used electronic coupon, among the electronic coupons corresponding to the information terminal 102. For example, control is implemented such that the validated electronic coupon can be selected in the menu screen of the application displayed on the display unit of the information terminal 102, and the user can select the next electronic coupon.

As described above, in the information processing system 100 according to the present embodiment, the user inputs evaluation information of food, etc., corresponding to the used electronic coupon, so that the user can use a new electronic coupon. Therefore, according to the present embodiment, by the information processing system 100 that controls the usage rights for food or services provided at a facility, it is possible to provide the facility users with contents that can motivate the facility users to use the facility more often, and to collect more reliable evaluation results.

Note that in the present embodiment, it is important that the benefit that can be obtained by using the electronic coupon is high, and an example of an operation method for increasing the benefit obtained with the electronic coupon will be described later.

### <Hardware Configuration>

Subsequently, examples of the hardware configuration of the management server 101 and the information terminal 102 will be described.

### (Hardware Configuration of Management Server)

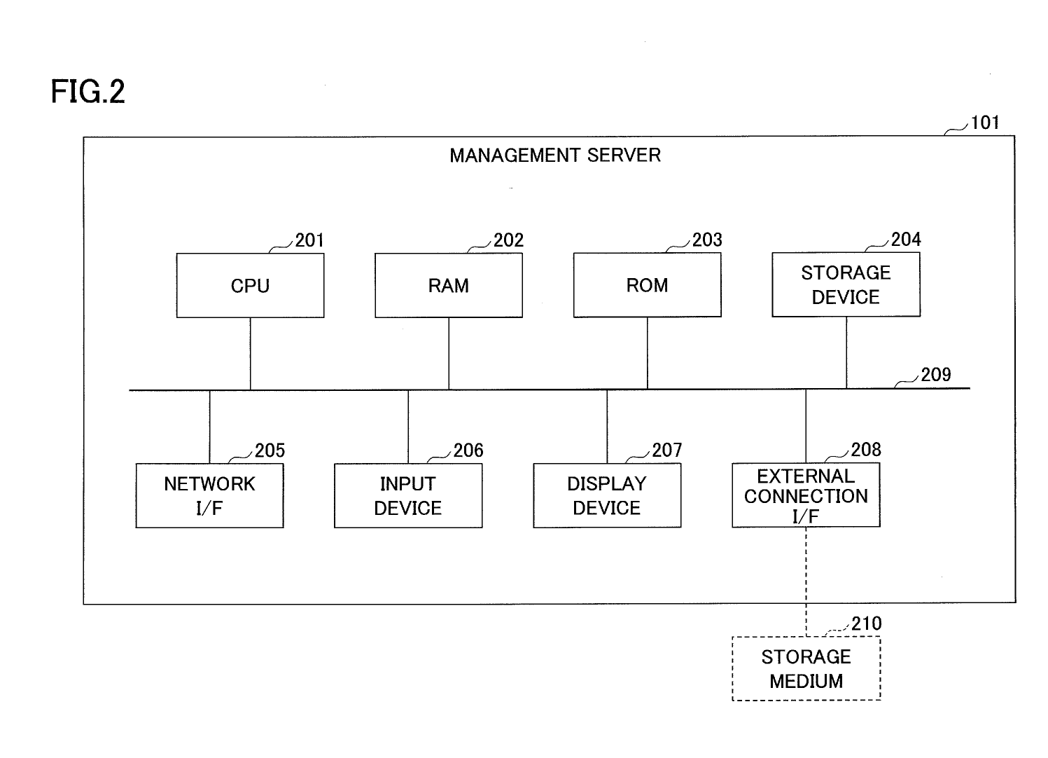

FIG. 2 is a diagram illustrating an example of a hardware configuration of the management server according to an embodiment. The management server 101 has a configuration of a general computer and includes, for example, a Central Processing Unit (CPU) 201, a Random Access Memory (RAM) 202, a Read-Only Memory (ROM) 203, a storage device 204, a network Interface (I/F) 205, an input device 206, a display device 207, an external connection I/F 208, and a bus 209, etc.

The CPU 201 is an arithmetic device that implements each function of the management server 101 by loading programs and data stored in the ROM 203 or the storage device 204, etc., into the RAM 202 and executing processes. The RAM 202 is a volatile memory used as a work area, etc., of the CPU 201. The ROM 203 is a nonvolatile memory capable of holding programs and data even when the power is turned off.

The storage device 204 is a mass storage device such as a Hard Disk Drive (HDD) or a Solid State Drive (SSD), for example, and stores an Operating System (OS), an application program, and various kinds of data, etc.

The network I/F 205 is a communication interface for connecting the management server 101 to the network 107. The input device 206 is a pointing device such as a mouse or an input device such as a keyboard, and is used to input operation signals to the management server 101. The display device 207 is, for example, a display, and displays processing results, etc., obtained by the management server 101.

The external connection I/F 208 is an interface for connecting an external device to the management server 101. The external device includes, for example, a storage medium 210, etc. The management server 101 can read information from and/or write information in the storage medium 210 via the external connection I/F 208. The storage medium 210 includes, for example, an optical disk, a magnetic disk, a memory card, and a Universal Serial Bus (USB) memory, etc. Furthermore, the management server 101 stores a predetermined program in the storage medium 210, and installs the program stored in the storage medium 210, into the management server 101 via the external connection I/F 208, whereby the predetermined program becomes executable.

The bus 209 is connected to each of the above-described elements and transmits address signals, data signals, and various kinds of control signals, etc.

### (Hardware Configuration of Information Terminal)

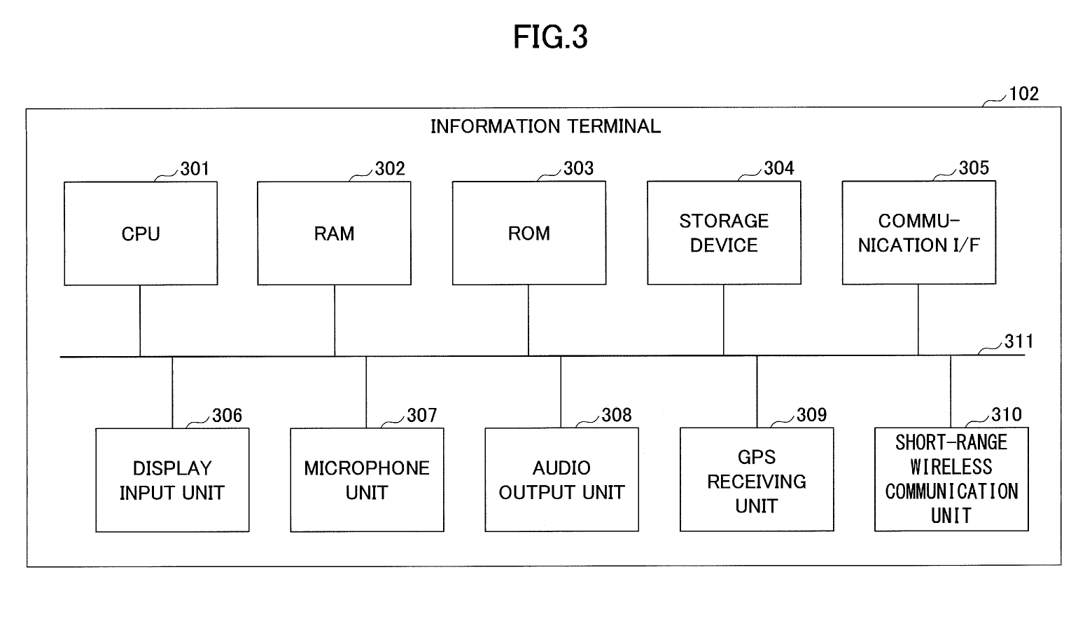

FIG. 3 is a diagram illustrating an example of a hardware configuration of the information terminal according to an embodiment. The information terminal 102 has a configuration of a general computer, and includes, for example, a CPU 301, a RAM 302, a ROM 303, a storage device 304, a communication I/F 305, a display input unit 306, a microphone unit 307, an audio output unit 308, a Global Positioning System (GPS) receiving unit 309, a short-range wireless communication unit 310, and a bus 311, etc.

The CPU 301 is an arithmetic device that implements each function of the information terminal 102 by loading programs and data stored in the ROM 303 and the storage device 304, etc., into the RAM 302, and executing processes. The RAM 302 is a volatile memory used as a work area, etc., of the CPU 301. The ROM 303 is a nonvolatile memory capable of holding programs and data even when the power is turned off. The storage device 304 is a storage device such as an HDD, an SSD, and a flash ROM, etc., and stores an OS, application programs, and various kinds of data, etc.

The communication I/F 305 is, for example, a communication interface compatible with a mobile communication network such as LTE or wireless communication such as wireless LAN, etc. The information terminal 102 can connect to the network 107 and can communicate with the management server 101, etc., by using the communication I/F 305.

The display input unit 306 is, for example, a display input device such as a touch panel display, and displays a display screen by a program, etc., executed by the information terminal 102 and also accepts an input operation by a user. Note that the display input unit 306 may include a display device and an input device provided separately.

The microphone unit 307 includes a microphone that acquires sound waves around the information terminal 102, and an amplifier circuit that amplifies the audio signals acquired by the microphone, etc. The audio output unit 308 includes an amplifier circuit that amplifies the audio signals, and a speaker that converts the audio signals into sound, etc. The GPS receiving unit 309 is a positioning device that receives positioning signals transmitted from a GPS satellite, etc., and outputs position information (for example, latitude and longitude, etc.) indicating the position of the information terminal 102.

The short-range wireless communication unit 310 includes, for example, a wireless communication circuit, an antenna, and a communication control circuit, etc., for performing short-distance wireless communication, such as BLE. The bus 311 is connected to each of the above-described elements and transmits address signals, data signals, and various kinds of control signals, etc.

### <Functional Configuration>

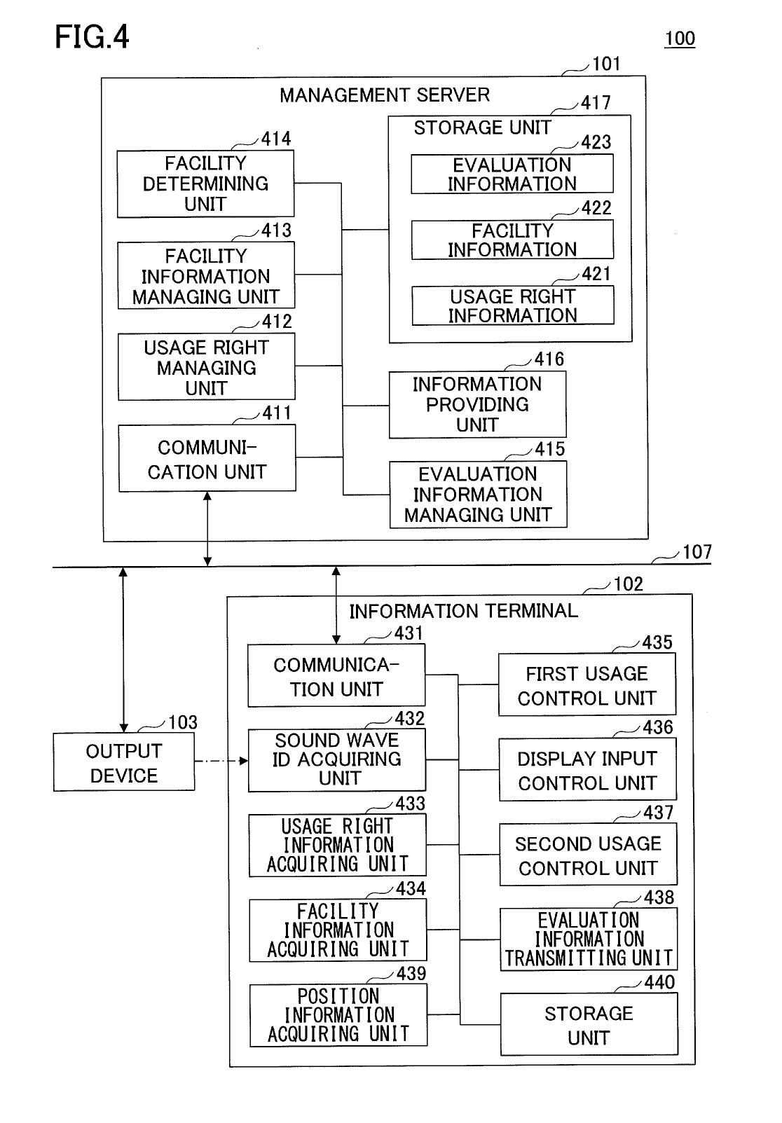

FIG. 4 is a diagram illustrating an example of the functional configuration of the management server and the information terminal according to an embodiment.

### (Functional Configuration of Management Server)

The management server 101 includes, for example, a communication unit 411, a usage right managing unit 412, a facility information managing unit 413, a facility determining unit 414, an evaluation information managing unit 415, an information providing unit 416, and a storage unit 417, etc.

For example, the management server 101 implements each of the above-described functional configurations by executing a predetermined program in the CPU 201 in FIG. 2. At least a part of the above-described functional configurations may be implemented by hardware.

For example, the communication unit 411 is implemented by programs executed by the CPU 201 and the network I/F 205, etc., and connects the management server 101 to the network 107, and communicates with the information terminal 102 and the output device 103, etc.

The usage right managing unit 412 stores and manages information of electronic coupons (examples of usage rights) corresponding to each of the one or more information terminals 102a, 102b, 102c, . . . , for example, in usage right information 421 as illustrated in FIG. 5, for example. Specifically, the coupons are stocked as a store clerk, etc., of each store registers the coupons in the management server 101, and as a result, the coupon can be provided to the information terminal 102 by the usage right managing unit 412.

FIG. 5 illustrates an image of an example of the usage right information 421 according to one embodiment. In the example of FIG. 5, the usage right information 421 includes information such as “application ID”, “store ID”, “coupon ID”, “coupon name”, “usage state”, and “evaluation state”, etc.

“Application ID” is identification information for identifying one or more of the information terminals 102a, 102b, 102c, . . . “Store ID” is identification information for identifying stores such as the store A 105a, the store B 105b, . . . “Coupon ID” is information for identifying each electronic coupon.

“Usage state” is information indicating the usage status of each electronic coupon. For example, “used” indicates a state in which the electronic coupon has already been used and thus cannot be used, and “unused” indicates a state in which the electronic coupon has not yet been used and thus can be used.

“Evaluation state” is information indicating the evaluation state of each electronic coupon. For example, “evaluated” indicates a state in which evaluation information of food, etc., corresponding to used electronic coupons has been input, and “unevaluated” indicates a state in which evaluation information has not been input.

In response to a usage right information acquisition request transmitted from the information terminal 102, for example, the usage right managing unit 412 provides, to the information terminal 102, the usage right information corresponding to the application ID of the information terminal 102, among the usage right information 421 as illustrated in FIG. 5. For example, upon receiving a usage right information acquisition request including an application ID “A1000001” from the information terminal 102a, the usage right managing unit 412 transmits usage right information 501 corresponding to the application ID “A1000001” among the usage right information 421, to the information terminal 102a that is the request source.

Furthermore, in accordance with the information, which indicates that the usage state and the evaluation state of the coupon have been changed, transmitted from the information terminal 102, the usage right managing unit 412 updates the “usage state” and the “evaluation state”, etc., in the usage right information 421 illustrated in FIG. 5.

Note that the usage right information 421 illustrated in FIG. 5 is an example. For example, the usage right managing unit 412 may delete the information of an electronic coupon for which the usage state is “used” and the evaluation state is “evaluated”.

Referring back to FIG. 4, the description of the functional configuration of the management server 101 will be continued.

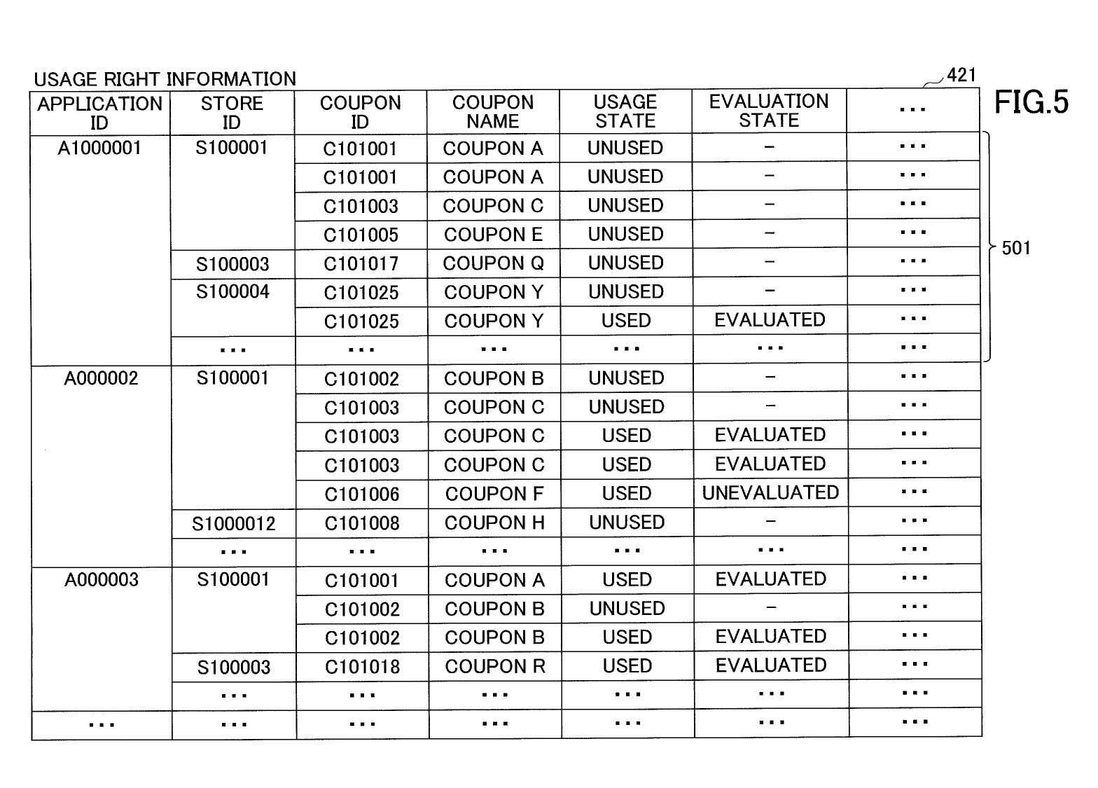

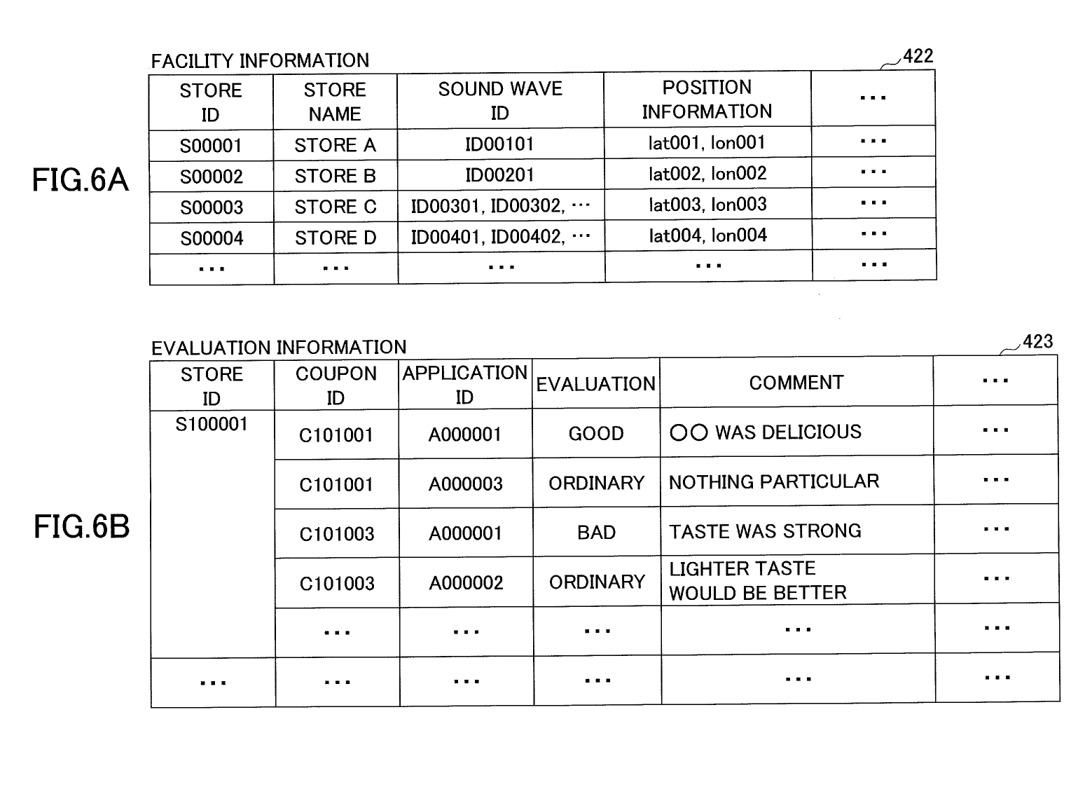

The facility information managing unit 413 stores and manages information on stores (an example of facilities) such as the store A 105a, the store B 105b, . . . , in facility information 422 as illustrated in FIG. 6A, for example.

FIG. 6A illustrates an image of an example of the facility information 422 according to one embodiment. In the example of FIG. 6A, the facility information 422 includes information such as “store ID”, “store name”, “sound wave ID”, and “position information”.

“Store ID” is identification information for identifying each store. “Store name” is information indicating the name of a store corresponding to the store ID. “Sound wave ID” is information indicating a sound wave ID included in sound waves output at a store corresponding to a store ID. Note that when a plurality of the output devices 103 are installed in a store, and sound waves including different sound wave IDs are output, a plurality of sound wave IDs are stored in “sound wave ID”.

“Position information” is position information (for example, information of latitude and longitude, etc.) indicating the position of each store. As a preferable example, when a usage right information acquisition request transmitted from the information terminal 102 includes the position information of the information terminal 102, the usage right managing unit 412 uses the “position information” included in the facility information 422 to identify a store located in the vicinity of the information terminal 102. Furthermore, the usage right managing unit 412 also provides, to the information terminal 102, the usage right information corresponding to the application ID of the information terminal 102 and also corresponding to the store ID of the store located in the vicinity of the information terminal 102, from the usage right information 421 as illustrated in FIG. 5.

Here, returning to FIG. 4, the description of the functional configuration of the management server 101 will be further continued.

In response to a store information acquisition request including a sound wave ID acquired by the information terminal 102 and the application ID of the information terminal 102, the facility determining unit (determining unit) 414 searches the facility information 422 as illustrated in FIG. 6A, and determines whether the information terminal 102 is within any of the stores. For example, when the sound wave ID included in the store information acquisition request is stored in the facility information 422, the facility determining unit 414 determines that the information terminal 102 is in the store of the store ID corresponding to the sound wave ID. Furthermore, when the sound wave ID included in the store information acquisition request is not stored in the facility information 422, the facility determining unit 414 determines that the information terminal 102 is not within any of the stores.

Furthermore, upon determining that the information terminal 102 is within the store of the store ID corresponding to the sound wave ID, the facility determining unit 414 transmits the store information such as the store ID and store name corresponding to the sound wave ID, to the information terminal 102 that is the request source. On the other hand, upon determining that the information terminal 102 is not within any of the stores, for example, the facility determining unit 414 transmits information indicating that there is no store corresponding to the sound wave ID to the information terminal 102 that is the request source.

The evaluation information managing unit 415 collects evaluation information including the application ID and the coupon ID, etc., transmitted by the information terminal 102, and stores and manages the evaluation information in evaluation information 423 as illustrated in FIG. 6B, for example.

FIG. 6B illustrates an image of an example of the evaluation information 423 according to one embodiment. In the example of FIG. 6B, the evaluation information 423 includes information such as “store ID”, “coupon ID”, “application ID”, “evaluation”, and “comment”, etc.

“Store ID” is identification information for identifying each store. “Coupon ID” is identification information for identifying each coupon. “Application ID” is identification information for identifying each information terminal 102.

“Evaluation” and “comment” are examples of evaluation information on food, etc., corresponding to an electronic coupon. In the example of FIG. 6B, “evaluation” is expressed by information such as good, ordinary, and bad, for example. However, this information is only an example, and “evaluation” may be information in any form such as a score, a number of stars, good/bad, whether voted as “good”, etc. “Comment” is a character string, etc., evaluating the food, etc., input by the user.

By using the evaluation information 423 collected by the evaluation information managing unit 415, the information providing unit 416 provides information to, for example, stores and restaurants, and business operators, etc., that develop menus for food, etc. For example, from the evaluation information 423 as illustrated in FIG. 6B, the information providing unit 416 tabulates, for each coupon ID, information such as “evaluation” and “comment”, etc., corresponding to the store ID “S100001”, and provides the tabulated information to the store A 105a of the store ID “S100001”.

The storage unit 417 is implemented by, for example, programs executed by the CPU 201, the storage device 204, and the RAM 202, etc., illustrated in FIG. 2, and stores various kinds of information such as the usage right information 421, the facility information 422, and the evaluation information 423.

### (Functional Configuration of Information Terminal)

The information terminal 102 includes, for example, a communication unit 431, a sound wave ID acquiring unit 432, a usage right information acquiring unit 433, a facility information acquiring unit 434, a first usage control unit 435, a display input control unit 436, a second usage control unit 437, an evaluation information transmitting unit 438, a position information acquiring unit 439, and a storage unit 440, etc.

For example, the information terminal 102 implements each of the above-described functional configurations by executing an application corresponding to the information processing system 100 by the CPU 301 illustrated in FIG. 3. Note that at least a part of each of the above functional configurations may be implemented by hardware or other programs such as an OS executed by the CPU 301.

The communication unit 431 is implemented by, for example, a program executed by the CPU 301 and the communication I/F 305, etc., illustrated in FIG. 3, and connects the information terminal 102 to the network 107 to communicate with the management server 101, etc.

The sound wave ID acquiring unit 432 collects sound waves around the information terminal 102 by using the microphone unit 307, etc., in FIG. 3, for example, and acquires a sound wave ID included in the collected sound waves.

The usage right information acquiring unit 433 acquires information of the electronic coupon corresponding to the information terminal 102 from the management server 101. For example, the usage right information acquiring unit 433 acquires, from the management server 101, information corresponding to the application ID of the information terminal 102 from the usage right information 421 as illustrated in FIG. 5, and stores the acquired information in the storage unit 440.

Preferably, the usage right information acquiring unit 433 transmits, to the management server 101, a usage right information acquisition request including the position information acquired by using the position information acquiring unit and the application ID, when the application is activated, etc.

In response to this usage right information acquisition request, the usage right managing unit 412 of the management server 101 transmits, to the information terminal 102 from the usage right information 421 as illustrated in FIG. 5, the usage right information corresponding to the application ID of the information terminal 102 and corresponding to the store ID of a store in the vicinity of the information terminal 102.

In this way, the usage right information acquiring unit 433 may selectively acquire the electronic coupon of a store in the vicinity of the information terminal 102, from among the pieces of information of electronic coupons corresponding to the information terminal 102.

The facility information acquiring unit 434 transmits, to the management server 101, a store information acquisition request including the sound wave ID acquired by the sound wave ID acquiring unit 432 and the application ID of the information terminal 102, and acquires store information such as the store ID and a store name (an example of facility information), reported from the management server 101. Note that when the facility information acquiring unit 434 can acquire the store ID and store information such as the store name, etc., the information terminal 102 can determine that the information terminal 102 is in the store corresponding to the store information.

When the information terminal 102 is in the store, the first usage control unit 435 enables the usage of an electronic coupon corresponding to the store ID of the store, among the electronic coupons corresponding to the information terminal 102.

For example, when the information terminal 102 is in the store A 105a, the first usage control unit 435 enables the usage of an electronic coupon corresponding to the store ID of the store A 105a, among the electronic coupons corresponding to the information terminal 102. On the other hand, the first usage control unit 435 does not enable the usage of an electronic coupon corresponding to a store ID different from the store ID of the store A 105a.

Here, when an electronic coupon, which is made available for usage, is selected by the user, for example, the electronic coupon is displayed on the display input unit 306 of the information terminal 102 in a manner such that the electronic coupon can be used in the store. On the other hand, for example, when an electronic coupon, which is not made available for usage, is selected by the user, the electronic coupon is displayed on the display input unit 306 of the information terminal 102 in a manner such that the electronic coupon cannot be used in the store.

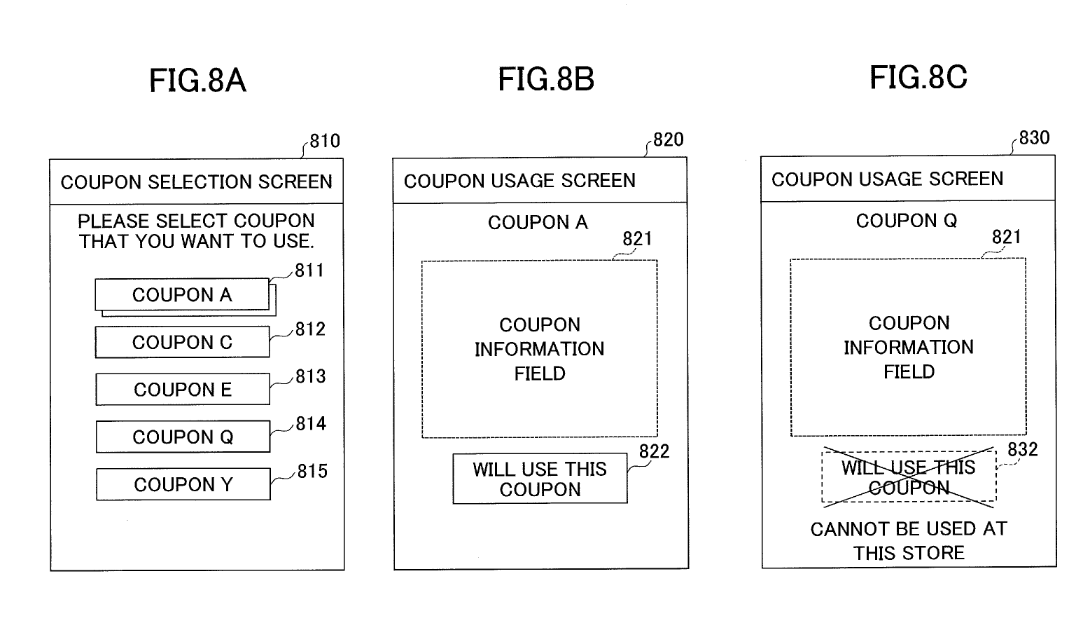

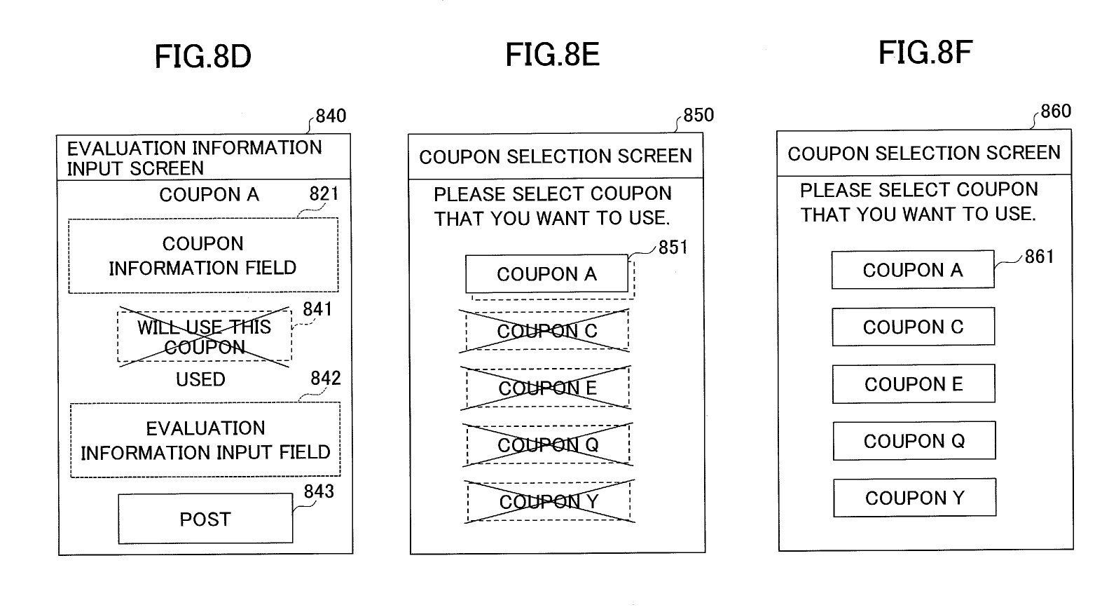

The display input control unit (display control unit) 436 causes the display input unit 306 to display various display screens as illustrated in FIGS. 8A to 8F, for example, and also accepts a user's operation on the display input unit 306.

For example, the display input control unit 436 causes the display input unit 306 to display an electronic coupon selection screen 810 as illustrated in FIG. 8A, and accepts an electronic coupon selection operation by the user. Furthermore, when an electronic coupon that is available for usage is selected, the display input control unit 436 causes the display input unit 306 to display an electronic coupon usage screen 820 as illustrated in FIG. 8B, for example, and accepts an electronic coupon usage operation by the store clerk, etc., of the store. Furthermore, after the electronic coupon is used according to the electronic coupon usage operation by the store clerk, etc., for example, the display input control unit 436 displays an evaluation information input screen 840 as illustrated in FIG. 8D on the display input unit 306, and requests input of evaluation information on food, etc., corresponding to the electronic coupon.

The second usage control unit 437, for example, controls whether to validate an electronic coupon other than the used electronic coupon, in the information terminal 102, in accordance with the presence or absence of input of evaluation information (predetermined information) in the evaluation information input screen 840 as illustrated in FIG. 8D.

For example, when evaluation information is not input in the evaluation information input screen 840 as illustrated in FIG. 8D, the second usage control unit 437 invalidates an electronic coupon other than the used electronic coupon, among the electronic coupons corresponding to the information terminal 102, in the information terminal 102. Accordingly, the display input control unit 436 causes the display input unit 306 to display an electronic coupon selection screen 850 as illustrated in FIG. 8E, for example. In the example of FIG. 8E, on the electronic coupon selection screen 850, the electronic coupons other than the used electronic coupon (for example, the coupon A), are displayed in a manner such that these electronic coupons cannot be selected.

On the other hand, when the evaluation information is input to the evaluation information input screen 840 as illustrated in FIG. 8D, the second usage control unit 437 validates the electronic coupons other than the used electronic coupon, among the electronic coupons corresponding to the information terminal 102, in the information terminal 102. Accordingly, the display input control unit 436 causes the display input unit 306 to display an electronic coupon selection screen 860 as illustrated in FIG. 8F, for example. In the example of FIG. 8F, on the electronic coupon selection screen 860, the electronic coupons other than the used electronic coupon (for example, the coupon A), are displayed in a manner such that these electronic coupons can be selected. Note that each of the display screens illustrated in FIGS. 8A to 8F will be described in detail in the description of the process flow to be described later.

For example, the evaluation information transmitting unit 438 transmits the evaluation information input in the evaluation information input screen 840 as illustrated in FIG. 8D, to the management server 101, together with the coupon ID of the electronic coupon corresponding to the evaluation information and the application ID of the information terminal 102.

The position information acquiring unit 439 acquires the position information of the information terminal 102, for example, by using the GPS receiving unit 309, etc., illustrated in FIG. 3.

The storage unit 440 is implemented by, for example, programs executed by the CPU 301, and the storage device 304 and the RAM 302, etc., illustrated in FIG. 3, and stores various kinds of information such as the usage right information acquired by the usage right information acquiring unit 433.

### <Process Flow>

Subsequently, the process flow of an information processing method according to a first embodiment will be described.

### First Embodiment

### (Activation Process and Store Entering Process-First Embodiment)

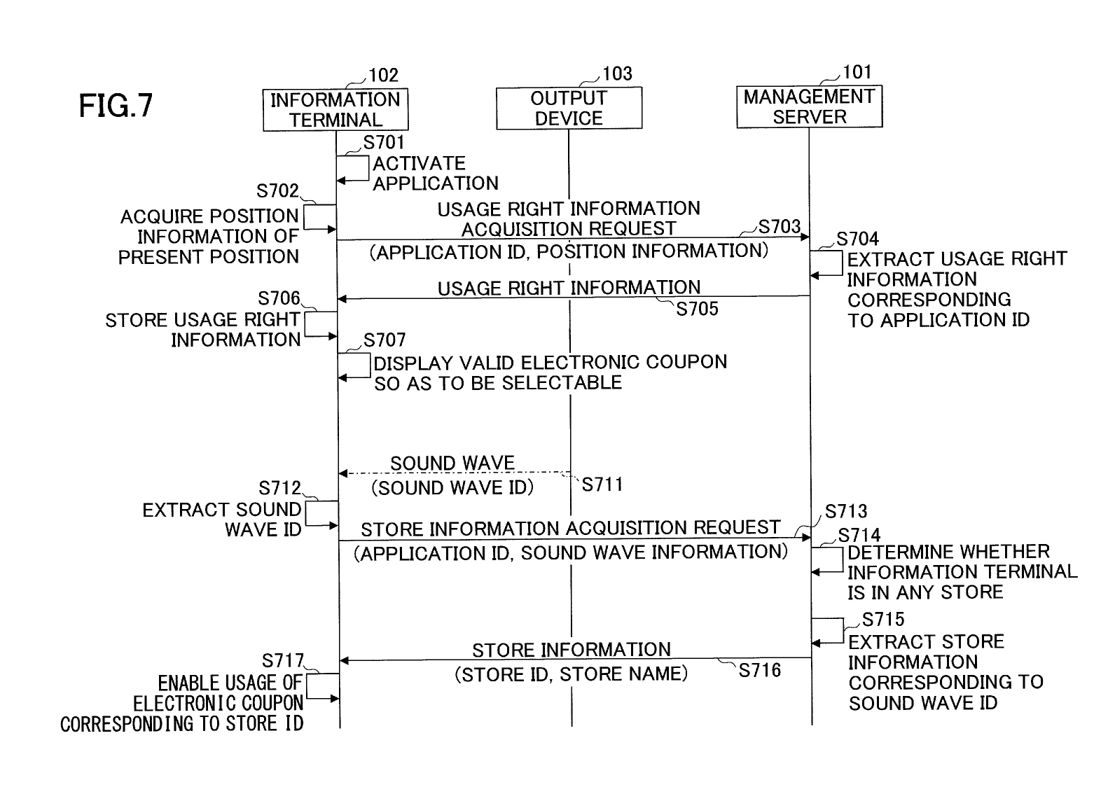

FIG. 7 is a sequence diagram illustrating an example of an activation process and a store entering process according to the first embodiment. The process illustrated in steps S701 to S707 in FIG. 7 is an example of an activation process executed, for example, when an application corresponding to the information processing system 100 is activated in the information terminal 102. Furthermore, the process illustrated in steps S711 to S716 is an example of a store entering process executed, for example, when the information terminal 102 enters a store where the output device 103 is installed.

In step S701, for example, when an application corresponding to the information processing system 100 is activated by a user, etc., of the information terminal 102, for example, an activation process as illustrated in steps S702 to S706 is executed.

In step S702, the usage right information acquiring unit 433 of the information terminal 102 acquires the position information of the information terminal 102 by using the position information acquiring unit 439.

In step S703, the usage right information acquiring unit 433 of the information terminal 102 transmits, to the management server 101 via the communication unit 431, a usage right information acquisition request including the acquired position information and the application ID of the information terminal 102.

Note that the acquisition of the position information in step S702 and the transmission of the position information in step S703 are optional and are not indispensable.

In step S704, the usage right managing unit 412 of the management server 101 extracts, for example, from the usage right information 421 as illustrated in FIG. 5, usage right information corresponding to the application ID included in the usage right information acquisition request received from the information terminal 102.

As a preferable example, the usage right managing unit 412 uses the position information included in the usage right information acquisition request and the facility information 422 to extract, from among the extracted pieces of usage right. information, the usage right information corresponding to the store ID of a store in the vicinity of the position of the information terminal 102.

In step S705, the usage right managing unit 412 transmits the extracted usage right information to the information terminal 102 that is the request source, via the communication unit 411.

In step S706, the usage right information acquiring unit 433 of the information terminal 102 receives the usage right information transmitted from the management server 101, and stores the usage right information in the storage unit 440. Here, as an example, the following description will be given assuming that the application ID of the information terminal 102 is “A1000001”, and that the usage right information 501 corresponding to the application ID “A1000001”, among the pieces of usage right information 421 illustrated in FIG. 5, is received and stored in the storage unit 440.

In step S707, the display input control unit 436 of the information terminal 102 uses the usage right information 501 acquired by the usage right information acquiring unit 433 and stored in the storage unit 440, for example, to display the electronic coupon selection screen 810 as illustrated in FIG. 8A, on the display input unit 306.

FIG. 8A illustrates an image of an example of the electronic coupon selection screen 810 displayed on the display input unit 306 of the information terminal 102. In the example of FIG. 8A, selection buttons 811 to 815 for selecting valid electronic coupons, in the usage right information 501 corresponding to the application ID “A1000001” illustrated in FIG. 5, are displayed so as to be selectable.

Here, a valid electronic coupon is, for example, an electronic coupon whose evaluation state is not “evaluated”, in the usage right information 501 corresponding to the application ID “A1000001” illustrated in FIG. 5. An electronic coupon whose evaluation state is “evaluated”, cannot be used anymore, and does not need to receive evaluation information, and, therefore, such an electronic coupon is handled as an invalid electronic coupon. Alternatively, an electronic coupon whose evaluation state is “evaluated” may be deleted from the usage right information 501. In the example of FIG. 5, among the electronic coupons corresponding to the application .ID “A1000001”, the coupons A (two pieces), the coupon C, the coupon E, the coupon Q, and the coupon Y (1 piece) correspond to valid electronic coupons.

Next, the store entering process after step S711 will be described. Here, as an example, the following description will be given assuming that the information terminal 102 is the information terminal 102a illustrated in FIG. 1 and the output device 103 is the output device 103a illustrated in FIG. 1.

In steps S711 and S712, for example, when a user possessing the information terminal 102 enters the store A 105a, the sound wave ID acquiring unit 432 of the information terminal 102 acquires the sound waves output from the output device 103, and extracts a sound wave ID from the acquired sound waves.

In step S713, the facility information acquiring unit 434 of the information terminal 102 transmits, to the management server 101 via the communication unit 431, a store information acquisition request including the sound wave ID acquired by the sound wave ID acquiring unit 432 and the application ID of the information terminal 102.

In step S714, the facility determining unit 414 of the management server 101 uses the sound wave ID included in the store information acquisition request received from the information terminal 102, to search the facility information 422 as illustrated in FIG. 6A, for example, and determines whether the information terminal 102 is within any of the stores.

For example, when the sound wave ID included in the store information acquisition request is “ID00101”, the facility determining unit 414 can use the facility information 422 to determine that the information terminal 102 is in the store A 105a corresponding to the sound wave ID “ID00101”. On the other hand, when the sound wave ID included in the store information acquisition request is not stored in the facility information 422, the facility determining unit 414 can determine that the information terminal 102 is not in any of the stores.

When the facility determining unit 414 determines the information terminal 102 is in any one of the stores, the facility determining unit 414 executes the process of step S715. On the other hand, when the facility determining unit 414 determines that the information terminal 102 is not in any of the stores, for example, the facility determining unit 414 ends the process. Alternatively, when the facility determining unit 414 determines that the information terminal 102 is not in any of the stores, the facility determining unit 414 may transmit information indicating that the information terminal 102 is not in any of the stores, to the information terminal 102 that is the request source.

In step S715, the facility determining unit 414 of the management server 101 extracts, for example, from the facility information 422 as illustrated in FIG. 6A, store information such as the store ID and a store name, etc., corresponding to the sound wave ID included in the store information acquisition request.

In step S716, the facility determining unit 414 of the management server 101 transmits the extracted store information to the information terminal 102 that is the request source via the communication unit 411.

In step S717, the facility information acquiring unit 434 of the information terminal 102 acquires the store information transmitted from the management server 101. Furthermore, the display input control unit 436 enables the usage of the electronic coupon corresponding to the store ID included in the store information, among the valid electronic coupons displayed so as to be selectable in step S707.

Here, when the electronic coupon made available for usage is selected by the user, for example, the electronic coupon is displayed in the display input unit 306 of the information terminal 102 in a manner such that the electronic coupon can be used in the store. On the other hand, for example, when an electronic coupon, which is not made available for usage, is selected by the user, the electronic coupon is displayed on the display input unit 306 of the information terminal 102 in a manner such that the electronic coupon cannot be used in the store.

By the above process, when the application is activated, the information terminal 102 displays a valid electronic coupon corresponding to the information terminal 102 in a selectable manner. Furthermore, when the information terminal 102 enters the store where the output device 103 is installed, the electronic coupon corresponding to the store is made available for usage, among the valid electronic coupons corresponding to the information terminal.

### (Coupon Usage Process by Information Terminal-First Embodiment)

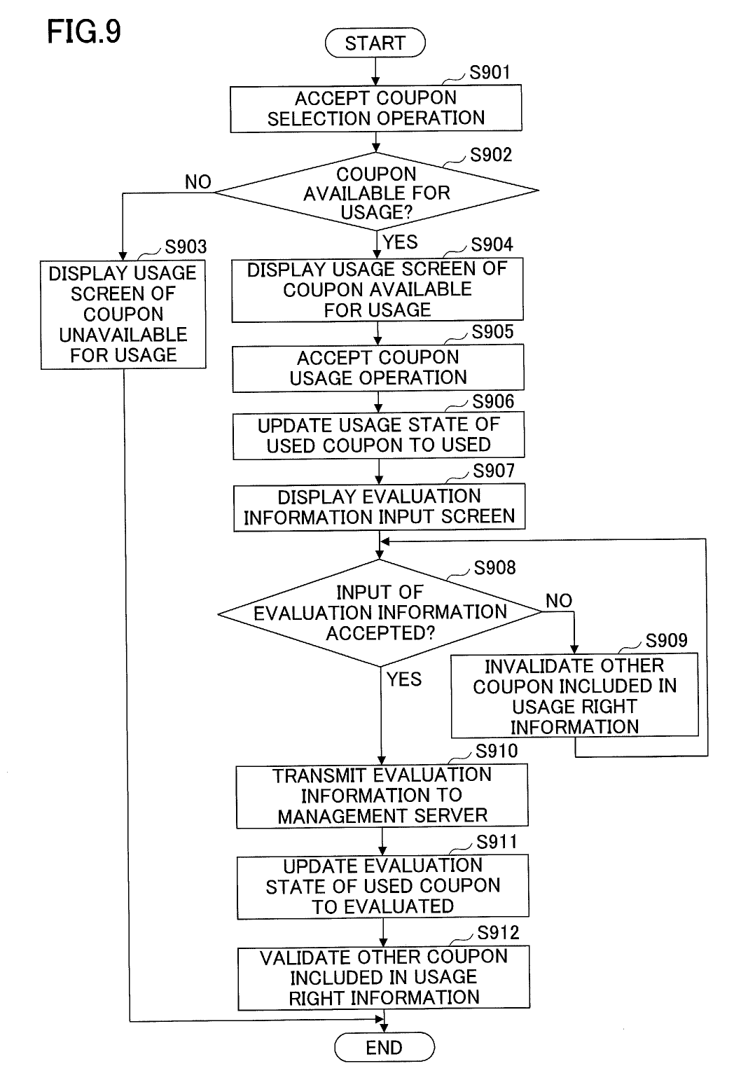

FIG. 9 is a flowchart illustrating an example of a coupon usage process according to the first embodiment. This process illustrates an example of a coupon usage process executed by the information terminal 102 when an electronic coupon is selected on the electronic coupon selection screen 810 as illustrated in FIG. 8A, for example.

In step S901, upon accepting an electronic coupon selection operation by a user, etc., on the electronic coupon selection screen 810 as illustrated in FIG. 8A, for example, the information terminal 102 executes the process in step S902 and subsequent steps.

In step S902, the display input control unit 436 of the information terminal 102 determines whether the selected electronic coupon is an electronic coupon available for usage in the store, upon being made available for usage in step S717 of FIG. 7.

When the selected electronic coupon is not an electronic coupon that is available for usage in the store, the display input control unit 436 causes the process to proceed to step S903. On the other hand, when the selected electronic coupon is an electronic coupon that is available for usage in the store, the display input control unit 436 causes the process to proceed to step S904.

In step S903, the display input control unit 436 causes the display input unit 306 to display an electronic coupon usage screen 830 of an unavailable electronic coupon, for example, as illustrated in FIG. 8C.

In the example of FIG. 8C, in the electronic coupon usage screen 830 of an unavailable electronic coupon (for example, the coupon Q), a coupon information field 821 for displaying photos and descriptions of food, etc., provided at a store, and information 832 indicating that the electronic coupon cannot be used, are displayed. In this way, when an electronic coupon that cannot be used is selected by the user, for example, control is implemented such that information of food, etc., corresponding to the electronic coupon can be viewed, but the electronic coupon cannot be used.

On the other hand, when proceeding from step S902 to step S904, the display input control unit 436 causes the display input unit 306 to display the electronic, coupon usage screen 820 of an available electronic coupon as illustrated in FIG. 8B, for example.

In the example of FIG. 8B, on the electronic coupon usage screen 820 of an available electronic coupon (for example, the coupon A), the coupon information field 821 for displaying photos and descriptions of food, etc., provided at the store, and a button 822 for performing an electronic coupon usage process by a store clerk, etc., are displayed.

In step S905, upon accepting a usage process (usage operation) by a store clerk, etc., of the store, in the electronic coupon usage screen 820 of an available electronic coupon, for example, the information terminal 102 executes the process in step S906 and subsequent steps.

For example, when a store clerk, etc., of the store selects the button 822 displayed on the electronic coupon usage screen 820 of an available electronic coupon, the electronic coupon is set as already used, and a process for using an electronic coupon for providing a benefit according to the electronic coupon to the user is executed. Note that the operation of selecting the button 822 displayed on the electronic coupon usage screen 820 is an example of a usage process by a store clerk, etc., of the store. The usage process by the store clerk of the store, etc., may be performed by short-range wireless communication with a Point of Sales (POS) terminal, etc., of the store, for example.

In step S906, the first usage control unit 435 of the information terminal 102 updates the usage state of the electronic coupon (electronic coupon for which the usage process has been executed) used in step S905, to “used”.

For example, the first usage control unit 435 changes the usage state of the used electronic coupon in the usage right information 501 stored in the storage unit 440 in step S706 of FIG. 7 to “used”, and changes the evaluation state to “unevaluated”. Furthermore, the first usage control unit 435 reports to the management server 101 that the electronic coupon for which the usage process has been executed, is already used.

In step S907, the display input control unit 436 of the information terminal 102 causes the display input unit 306 to display the evaluation information input screen 840, for example, as illustrated in FIG. 8D, corresponding to the electronic coupon used in step S905.

In the example of FIG. 8D, on the evaluation information input screen 840, the coupon information field 821, information 841 indicating that the electronic coupon cannot be used, an evaluation information input field 842, and a “post” button 843, etc., are displayed. For example, the user of the information terminal 102 inputs an evaluation comment, etc., in the evaluation information input field 842, and selects the “post” button 843, thereby posting an evaluation comment on the food, etc., corresponding to the electronic coupon. Note that the evaluation comment is an example of predetermined information regarding food corresponding to the electronic coupon. For example, predetermined information on food corresponding to the electronic coupon may be evaluation points such as a number of stars and a score, good/bad, or whether voted as “good”, etc. Furthermore, the predetermined information on the food corresponding to the electronic coupon may be an answer to a question in a questionnaire form, or may be information other than evaluation, for example, calling for a name of a menu item.

In step S908, the second usage control unit 437 of the information terminal 102 determines whether the display input control unit 436 has accepted input of evaluation information on the evaluation information input screen 840 as illustrated in FIG. 8D.

In a case where the input of the evaluation information has not been accepted, the second usage control unit 437 causes the process to proceed to step S909. On the other hand, when the input of the evaluation information has been accepted, the second usage control unit 437 causes the process to proceed to step S910.

In step S909, the second usage control unit 437 of the information terminal 102 invalidates an electronic coupon other than the electronic coupon used in step S905, among the electronic coupons included in the usage right information 501 stored in the storage unit 440.

For example, in the usage right information 501 corresponding to the application ID “A1000001” illustrated in FIG. 5, it is assumed that one coupon A has been used, among the valid coupons including the coupons A (2 pieces), the coupon C, the coupon E, the coupon Q, and the coupon Y (1 piece). In this case, the second usage control unit 437 invalidates. the coupon A (1 piece), the coupon C, the coupon E, the coupon Q, and the coupon Y (1 piece), among the above valid electronic coupons.

Thus, for example, as in the electronic coupon selection screen 850 illustrated in FIG. 8E, the invalidated coupons including the coupon A (1 piece), the coupon C, the coupon E, the coupon Q, and the coupon Y (1 piece) are displayed such that these coupons cannot be selected. Furthermore, when a selection button 851 for the used coupon A is selected in the electronic coupon selection screen 850, the evaluation information input screen 840 corresponding to the used coupon A as illustrated in FIG. 8D, is displayed again.

Note that when the process proceeds to step S909, when an electronic coupon other than the electronic coupon used in step S905 has already been invalidated, the second usage control unit 437 maintains the invalidated state.

On the other hand, when the process proceeds from step S908 to step S910, the evaluation information transmitting unit 438 of the information terminal 102 transmits, to the management server 101, the input evaluation information, together with the coupon ID of the used electronic coupon and the application ID of the information terminal 102.

In step S911, the second usage control unit 437 of the information terminal 102 updates the evaluation state of the used electronic coupon to “evaluated”, in the usage right information 501 corresponding to the information terminal 102 stored in the storage unit 440. Note that as described above, the electronic coupon whose evaluation state is “evaluated”, is handled as an invalid electronic coupon in subsequent processes.

In step S912, the second usage control unit 437 of the information terminal 102 validates an electronic coupon other than the electronic coupon used in step S905, among the electronic coupons included in the usage right information 501 stored in the storage unit 440.

For example, in the usage right information 501 corresponding to the application ID “A1000001” illustrated in FIG. 5, among the valid coupons including the coupons A (2 pieces), the coupon C, the coupon E, the coupon Q, and the coupon Y (1 piece), it is assumed that one piece of the coupon A has been used. In this case, the second usage control unit 437 excludes the used coupon A (1 piece) from the above-mentioned valid electronic coupons, and validates the coupon A (1 piece), the coupon C, the coupon E, the coupon Q, and coupon Y (1 piece).

Thus, for example, as illustrated in the electronic coupon selection screen 860 illustrated in FIG. 8F, the validated coupons including the coupon A (1 piece), the coupon C, the coupon E, the coupon Q, and the coupon Y (1 piece) are displayed in a manner such that these electronic coupons can be selected. Furthermore, when a selection button 861 for the unused coupon A is selected on the electronic coupon selection screen 860, for example, the electronic coupon usage screen 820 as illustrated in FIG. 8B is displayed.

Note that upon proceeding to step S909, when an electronic coupon other than the electronic coupon used in step S905 is in a valid state, the second usage control unit 437 maintains the valid state of the other electronic coupon.

### (Coupon Usage Process by Information Processing System-First Embodiment)

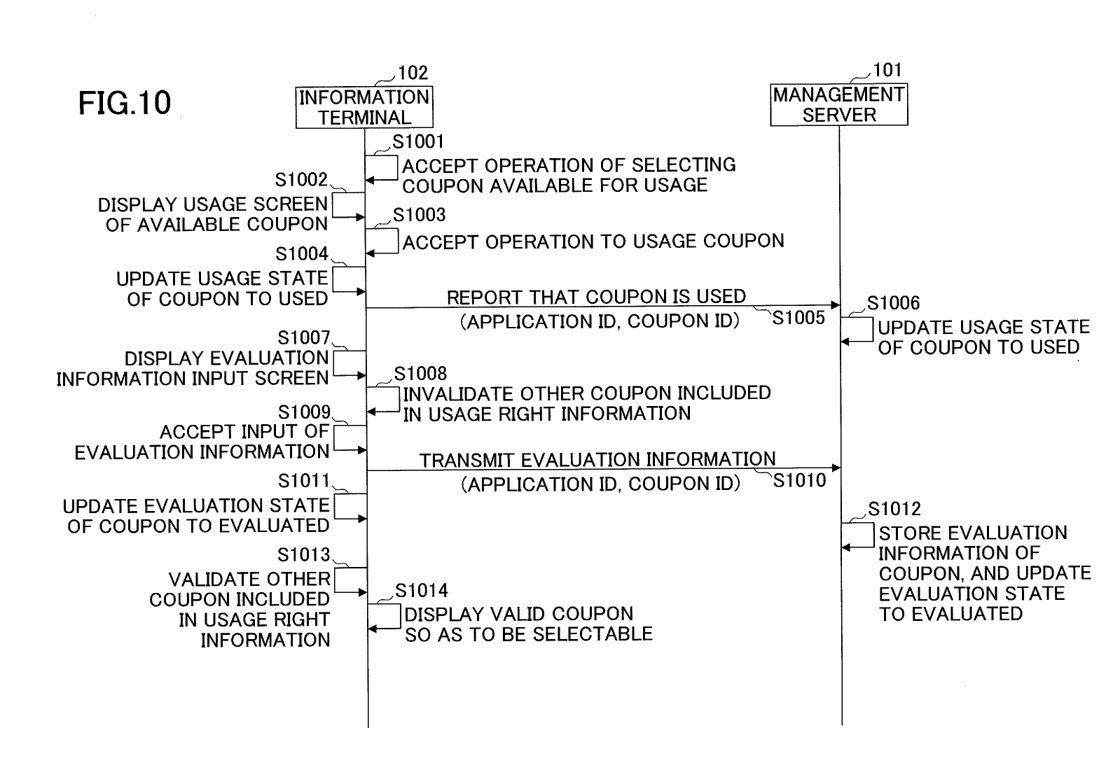

FIG. 10 is a sequence diagram illustrating an example of a coupon usage process according to the first embodiment. This process illustrates an example of the overall process in the information processing system 100, corresponding to the coupon usage process of the information terminal 102 illustrated in FIG. 9. Note that among the processes in FIG. 10, the processes related to the information terminal 102 .are the same as the processes of the information terminal 102 described with reference to FIG. 9, and, therefore, detailed descriptions thereof will be omitted here.

In step S1001, the display input control unit 436 of the information terminal 102 accepts an electronic coupon selection operation by a user, etc., on the electronic coupon selection screen 810 as illustrated in FIG. 8A, for example. Note that here, it is assumed that the user selects an electronic coupon (for example, the coupon A) that can be used in the store.

In step S1002, the display input control unit 436 of the information terminal 102 causes the display input unit 306 to display the electronic coupon usage screen 820 of an available electronic coupon as illustrated in FIG. 8B, for example. Note that this process corresponds to the processes of steps S902 and S904 of FIG. 9, for example.

In step S1003, it is assumed that the display input control unit 436 of the information terminal 102 accepts an electronic coupon usage operation by a store clerk, etc., of the store. Note that this process corresponds to the process of step S905 in FIG. 9, for example.

In steps S1004 and S1005, the first usage control unit 435 of the information terminal 102 updates the usage state of the used electronic coupon to “used”, and reports to the management server 101 that the electronic coupon has been used. This report includes, for example, a coupon ID of the used electronic coupon and the application ID of the information terminal 102, etc. Note that this process corresponds to the process of step S906 in FIG. 9, for example.

In step S1006, the usage right managing unit 412 of the management server 101 updates the usage state of the electronic coupon corresponding to the coupon ID and the application ID reported from the information terminal 102, to “used”, for example, in the usage right information 421 as illustrated in FIG. 5.

In step S1007, the display input control unit 436 of the information terminal 102 causes the display input unit 306 to display the evaluation information input screen 840, for example, as illustrated in FIG. 8D, corresponding to the used electronic coupon. Note that this process corresponds to the process of step S907 in FIG. 9, for example.

In step S1008, the second usage control unit 437 of the information terminal 102 invalidates an electronic coupon other than the used electronic coupon, among the electronic coupons included in the usage right information 501, until evaluation information is input to the evaluation information input screen 840. Note that this process corresponds to the processes of steps S908 and S909 in FIG. 9.

In steps S1009 and S1010, when the display input control unit 436 of the information terminal 102 accepts input of evaluation information, the evaluation information transmitting unit 438 transmits the accepted evaluation information to the management server 101. Note that this process corresponds to the processes of steps S908 and S910 of FIG. 9, for example.

In step S1011, the second usage control unit 437 of the information terminal 102 updates the evaluation state of the used electronic coupon, to “evaluated”. Note that this process corresponds to the process of step S911 of FIG. 9, for example.

In step S1012, the evaluation information managing unit 415 of the management server 101 stores the evaluation information received from the information terminal 102 together with the coupon ID and the application ID, in the evaluation information 423 as illustrated in FIG. 6B, for example. Furthermore, the usage right managing unit 412 of the management server 101 updates the evaluation state of the used electronic coupon in the usage right information 421 as illustrated in FIG. 5 to “evaluated”, for example.

In step S1013, the second usage control unit 437 of the information terminal 102 validates an electronic coupon other than the used electronic coupon, among the electronic coupons included in the usage right information 501 stored in the storage unit 440. Note that this process corresponds to the process of step S912 of FIG. 9, for example.

In step S1014, the display input control unit 436 of the information terminal 102 displays valid coupons so as to be selectable, among the electronic coupons included in the usage right information 501 stored in the storage unit 440. Accordingly, for example, the electronic coupon selection screen 860 as illustrated in FIG. 8F is displayed on the display input unit 306.

As described above, when the usage state or evaluation. state of the usage right information 501 stored by the information terminal 102 is updated, the. updated content is applied to the usage right information 421 stored by the management server 101. Furthermore, evaluation information of food, etc., corresponding to the electronic coupon, accepted by the information terminal 102, is collected and stored by the management server 101.

As described above, according to the present embodiment, the information terminal 102 implements control such that another electronic coupon cannot be used until evaluation information corresponding to the used electronic coupon is input, and implements control such that another electronic coupon can be used when the evaluation information is input.

Accordingly, according to the present embodiment, the information processing system 100 that controls the usage right with respect to food or services provided at the facilities, such as stores, can provide the facility users with content that can motivate the facility users to use the facility more often, and can collect more reliable evaluation results.

### Second Embodiment

In the first embodiment, for example, a description is given of an example in which, when evaluation information is input to the evaluation information input screen 840 as illustrated in FIG. 8D, for example, the electronic coupon, which has been invalidated in the electronic coupon selection screen 850 as illustrated in FIG. 8E, is validated.

In a second embodiment, a description is given of an example of a process in which, when the evaluation information is input in the evaluation information input screen 840, the information terminal 102 uses new usage right information reported from the management server 101, to display the electronic coupon selection screen.

### <Process Flow-Second Embodiment>

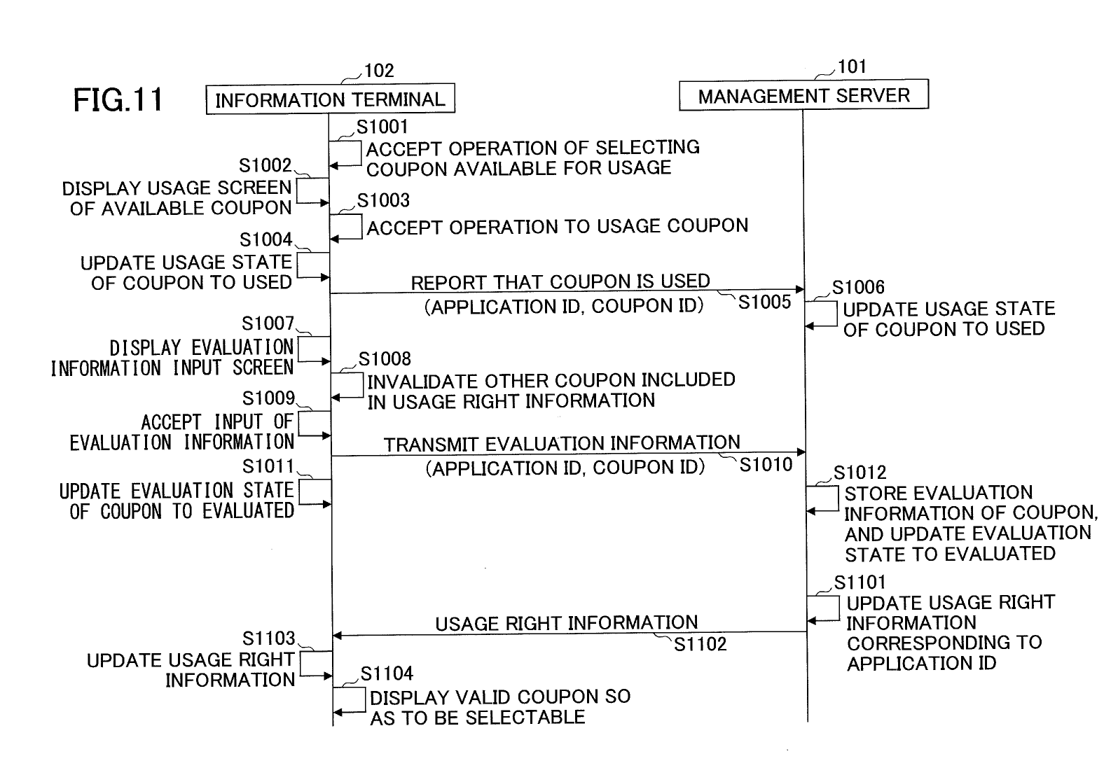

FIG. 11 is a sequence diagram illustrating an example of a coupon usage process according to the second embodiment. Note that among the processes illustrated in FIG. 11, the processes of steps S1001 to S1012 are the same as the processes of the first embodiment described with reference to FIG. 10, and, therefore, here, descriptions are given mainly of the differences from the processes of the first embodiment.

In step S1101, the usage right managing unit 412 of the management server 101 updates the usage right information corresponding to the application ID of the information terminal 102 that has accepted the evaluation information in step S1010.

For example, the usage right managing unit 412 may give a new electronic coupon set in advance to the information terminal 102 that has transmitted the evaluation information, or may analyze the evaluation information and give an electronic coupon according to the preference of the user, to the information terminal 102 that has transmitted the evaluation information.

In step S1102, the usage right managing unit 412 of the management server 101 transmits the updated usage right information to the information terminal 102 that has transmitted the evaluation information. At this time, the usage right managing unit 412 may transmit the usage right information on all of the electronic coupons corresponding to the application ID of the information terminal 102, or may transmit only the usage right information on the newly given electronic coupon.

In step S1103, the usage right information acquiring unit 433 of the information terminal 102 updates the usage right information 501 stored in the. storage unit 440, by using the usage right information reported from the management server 101.

In step S1104, the display input control unit 436 of the information terminal 102 displays valid coupons so as to be selectable, among the electronic coupons included in the updated usage right information 501 stored in the storage unit 440.

By the above processes, every time the information terminal 102 transmits the evaluation information to the management server 101, the information terminal 102 receives new usage right information reported from the management server 101, and the information terminal 102 uses this reported new usage right information to cause the display input unit 306 to display the electronic coupon selection screen 810 as illustrated in FIG. 8A.

Accordingly, the information processing system 100 can provide a new electronic coupon or an electronic coupon according to the user's preference, etc., in accordance with the evaluation information input by the user, for example.

### Third Embodiment

In the embodiment of FIG. 1, the information terminal 102 performs a store entering process by using the management server 101, for example, as illustrated in steps S711 to S717 in FIG. 7. However, this is only an example, and the information terminal 102 may perform the store entering process without using the management server 101.

In a third embodiment, a description is given of an example of a process in the case where the information terminal 102 performs the store entering process without using the management server 101.

### <Functional Configuration-Third Embodiment>

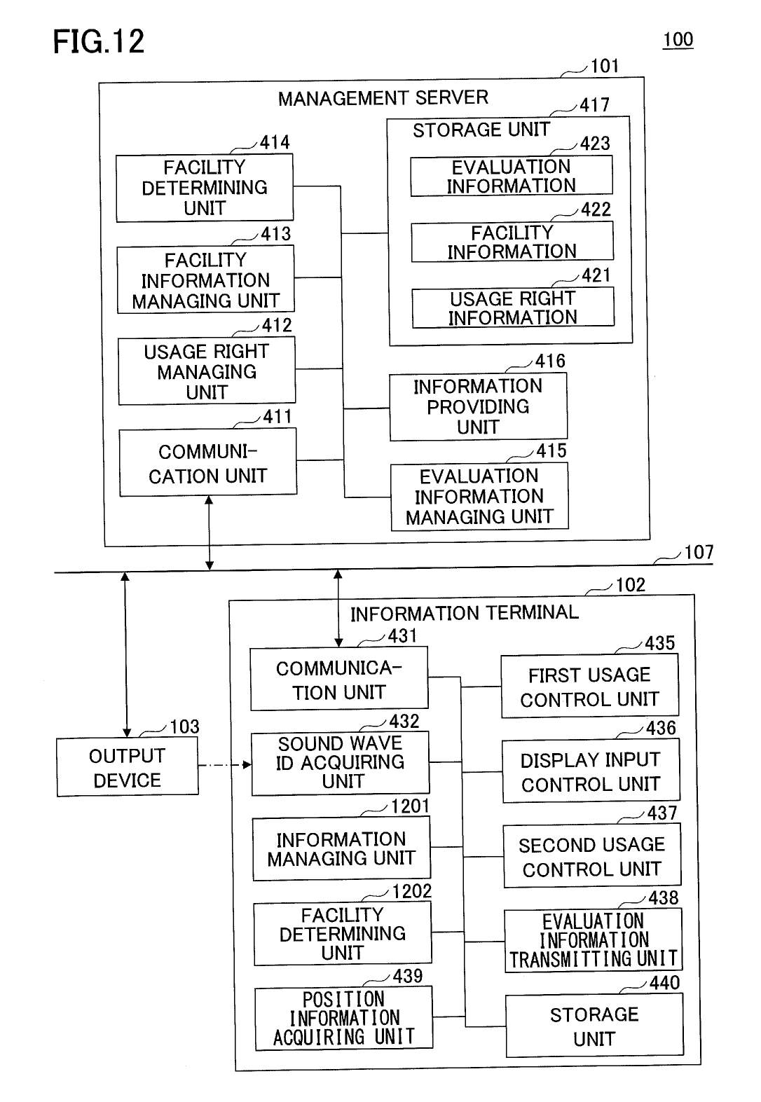

FIG. 12 is a diagram illustrating an example of the functional configuration of the management server and the information terminal according to the third embodiment. The information terminal 102 according to the third embodiment includes an information managing unit 1201 and a facility determining unit 1202, instead of the usage right information acquiring unit 433 and the facility information acquiring unit 434 of the information terminal 102 according to the first embodiment illustrated in FIG. 4.

The information managing unit 1201 is implemented by, for example, a program (application) executed by the CPU 301 in FIG. 3. For example, when the application is activated, the information managing unit 1201 acquires the usage right information 501 corresponding to the application ID .of the information terminal 102 and the facility information 422 as illustrated in FIG. 6A, from the management server 101, and stores and manages the acquired information in the storage unit 440. Accordingly, the information managing unit 1201 functions as a usage right managing unit that stores the usage right information 501, which is information of the electronic coupon corresponding to the information terminal 102, in the information processing system 100 according to the third embodiment.

The facility determining unit 1202 determines whether the information terminal 102 is in any of the stores, by using the facility information 422 acquired by the information managing unit 1201 and stored in the storage unit 440, and the sound wave ID acquired by the sound wave ID acquiring unit 432. Accordingly, in the information processing system 100 according to the third embodiment, the facility determining unit 1202 functions as a determining unit for determining whether the information terminal 102 is in any of the stores based on the sound wave ID included in the sound waves output in the store.

Note that the other functional configurations of the management server 101 and the information terminal 102 may be the same as the functional configurations according to the first embodiment illustrated in FIG. 4.

### <Process Flow-Third Embodiment>

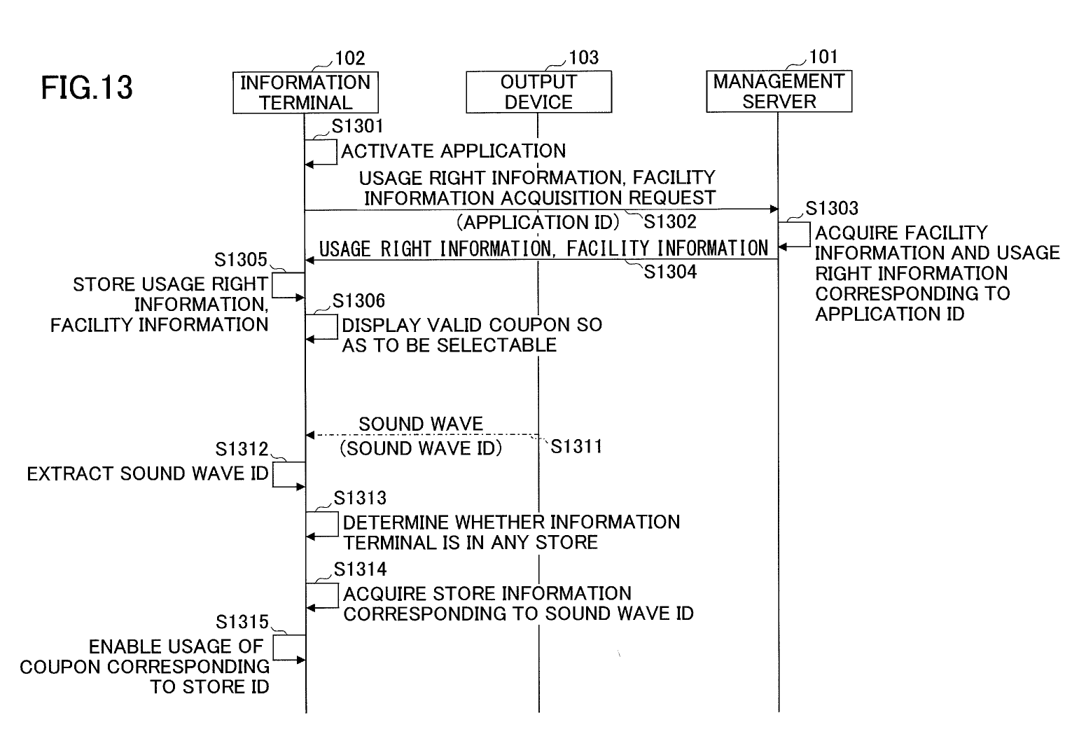

FIG. 13 is a sequence diagram illustrating an example of an activation process and a store entering process according to the third embodiment. Note that in the following description, it is assumed that the information terminal 102 is the information terminal 102a illustrated in FIG. 1.

In step S1301, for example, when an application corresponding to the information processing system 100 is activated by a user, etc., of the information terminal 102, the activation process of steps S1302 to S1306 is executed.

In step S1302, the information managing unit 1201 of the information terminal 102 transmits a usage right information and facility information acquisition request including the application ID of the information terminal 102, to the management server 101 via the communication unit 431.

In step S1303, the management server 101 acquires, for example, the usage right information 501 corresponding to the application ID included in the usage right information acquisition request, from the usage right information 421 as illustrated in FIG. 5, and also the facility information 422 as illustrated in FIG. 6A.

In step S1304, the management server 101 transmits the acquired usage right information 501 and the acquired facility information 422 to the information terminal 102 that is the request source, via the communication unit 411.

In step S1305, the information managing unit 1201 of the information terminal 102 stores and manages the usage right information 501 and the facility information 422 transmitted from the management server 101, in the storage unit 440.

In step S1306, the display input control unit 436 of the information terminal 102 uses the usage right information 501 stored by the information managing unit 1201, to display the electronic coupon selection screen 810 in which the valid electronic coupons are displayed so as to be selectable, for example, as illustrated in FIG. 8A.

Subsequently, the store entering process from step S1311 and beyond will be described. Here, as an example, the following description will be made assuming that the information terminal 102 is the information terminal 102a illustrated in FIG. 1.

In steps S1311 and S1312, for example, when a user possessing the information terminal 102 enters the store A 105a, the sound wave ID acquiring unit 432 of the information terminal 102 acquires the sound waves output from the output device 103, and extracts a sound wave ID from the acquired sound waves.

In step S1313, the facility determining unit 1202 of the information terminal 102 searches the facility information 422 stored in the storage unit 440 by using the sound wave ID acquired by the sound wave ID acquiring unit 432, and determines whether the information terminal 102 is in any of the stores.

When the facility determining unit 1202 determines that the information terminal 102 is in any of the stores stored in the facility information 422, the facility determining unit 1202 executes the process of step S1314. On the other hand, when the facility determining unit 1202 determines that the information terminal 102 is not in any of the stores stored in the facility information 422, the facility determining unit 1202 ends the process.

In step S1314, the facility determining unit 1202 of the information terminal 102 acquires, from the facility information 422 stored in the storage unit 440, store information such as a store ID and a store name, etc., corresponding to the sound wave ID acquired by the sound wave ID acquiring unit 432.

In step S1315, the display input control unit 436 of the information terminal 102 enables the usage of the electronic coupon corresponding to the store ID acquired in step S1314, among the valid electronic coupons displayed so as to be selectable in step S1306.

By the above processes, after acquiring the usage right information 501 and the facility information 422 in step S1304, the information terminal 102 can execute the store entering process even when the information terminal 102 cannot communicate with the management server 101.

### [Application Example]

Subsequently, examples of preferable usage scenes of the information processing system 100 according to the above embodiments will be described. In the information processing system 100, the information terminal 102 implements control so that another electronic coupon cannot be used until evaluation information on food, etc., corresponding to the used electronic coupon is input. Therefore, when the benefit obtained with the electronic coupon provided by the information processing system 100 is large for the user, it is possible to expect the user to proactively input evaluation information. On the other hand, when the benefit obtained with the electronic coupon provided by the information processing system 100 is small, it may not be possible to expect the user to proactively input evaluation information.

Therefore, here, examples of preferable usage scenes for increasing the benefit obtained with the electronic coupon provided by the information processing system 100 will be described.

### (Usage Scene 1)

For example, in a business entity, etc., having a relatively small number of employees (for example, approximately 10 to 30 employees), there are cases where a meal fee assisting system is provided instead of setting up a company cafeteria, etc. The subsidization for meal fees may be supplied to employees, for example, by using a portal application for employees operating on the information terminal 102 such as a smartphone. Note that the portal application for employees is an example of an application corresponding to the information processing system 100.

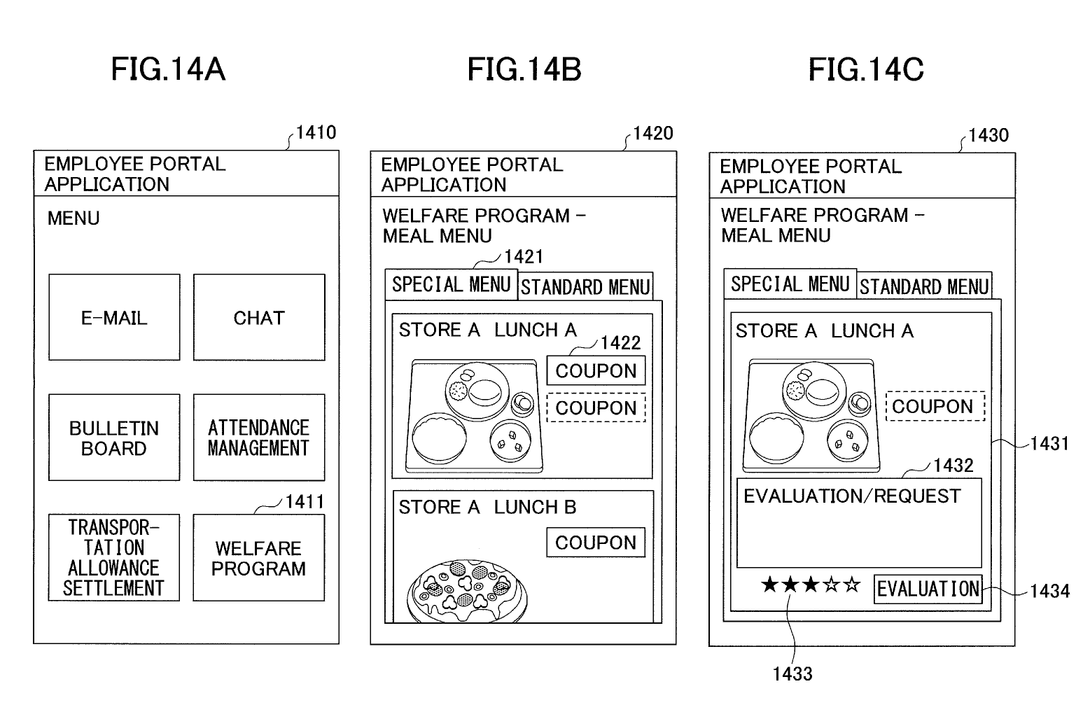

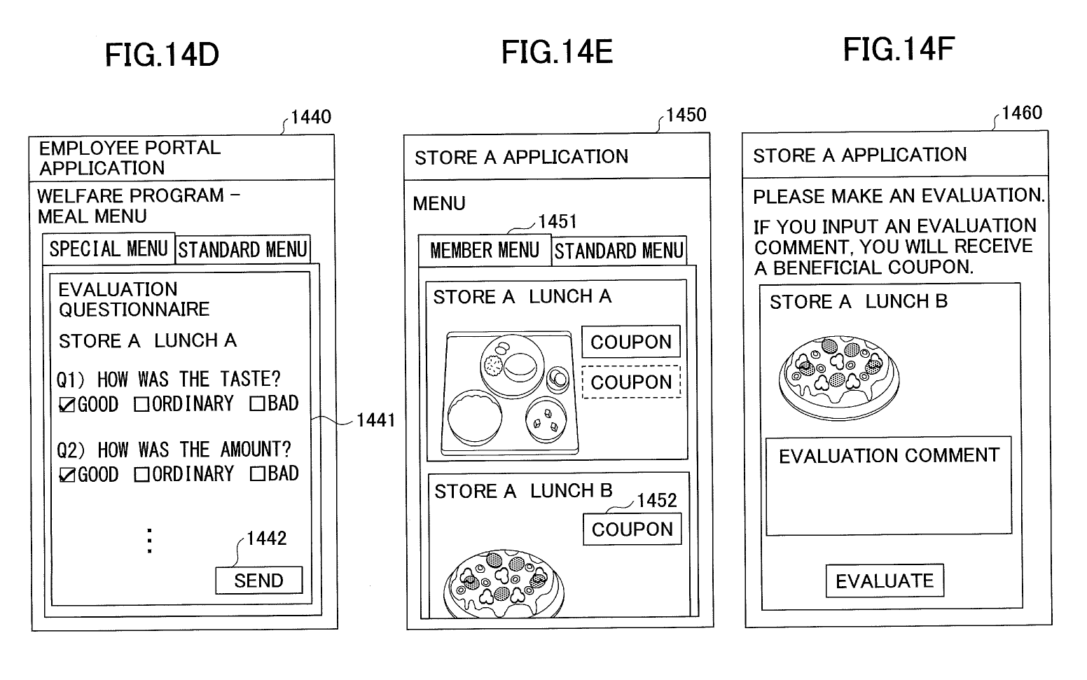

FIG. 14A illustrates an example of a menu screen 1410 of a portal application for employees. In the example of FIG. 14A, on the menu screen 1410, for example, in addition to menus such as “e-mail”, “chat”, “bulletin board”, “attendance management”, and “transportation allowance settlement”, which are used in company operations, a menu 1411 of “welfare program” is provided.

Employees who use this portal application for employees can cause a meal menu display screen 1420 as illustrated in FIG. 14B to be displayed, by selecting a “meal” menu from the “welfare program” menu 1411, etc. Furthermore, employees who use the portal application for employees can cause a special menu that can be used at neighboring stores (for example, cafeterias, restaurants, and coffee shops, etc.) to be displayed, by selecting a “special menu” tab 1421 in the meal menu display screen 1420.

For this special menu, for example, it is assumed that a cheaper price (for example, 500 yen for a lunch that costs 800 yen, etc.) than the market rate is set by subsidization for meal fees by a business operator or a special offer given by a store, etc.

The meal menu display screen 1420 is another example of the electronic coupon selection screen 810 illustrated in FIG. 8A, for example, and a valid electronic coupon 1422 corresponding to the information terminal 102 is displayed so as to be selectable.

For example, on the meal menu display screen 1420, by using the electronic coupon 1422, an employee can eat lunch A that is a special menu at a cheap price at the store A. Furthermore, when the electronic coupon 1422 is used, the information terminal 102 displays, for example, an evaluation information input screen 1431 as illustrated in FIG. 14C or an evaluation information input screen 1441 as illustrated in FIG. 14D on the display input unit 306. These evaluation information input screens 1431 and 1441 are other examples of the evaluation information input screen 840 illustrated in FIG. 8D.

In the example of FIG. 14C, on the evaluation information input screen 1431, an evaluation comment input field 1432, star marks 1433 for evaluating the meal on 5-point scale, and an “evaluation” button 1434 for transmitting the evaluation, etc., are displayed.

In the example of FIG. 14D, on the evaluation information input screen 1441, an evaluation questionnaire in a question form and a “send” button 1442 for transmitting the evaluation questionnaire are displayed.

Note that the evaluation information input screens illustrated in FIGS. 14C and 14D are examples, and the portal application for employees may collect various kinds of information relating to food, etc., corresponding to the electronic coupons, in response to requests from stores and restaurants, and business operators, etc., that develop menus for food, etc., for example.

In this manner, employees who use the portal application for employees can purchase a special menu at a cheaper price than the market rate by inputting evaluation information, and, therefore, it can be expected that such employees will proactively input evaluation information.

Furthermore, the store can provide a special menu at a cheaper price, for example, by using. subsidization for meal fees, etc., provided from the business operator, and, therefore, the store can attract the employees using the portal application for employees, as repeating customers. Furthermore, the store can receive the feedback of the evaluation information from the service provider, etc., who operates the information processing system 100, and, therefore, the store can apply the evaluation result not only to the special menu but also to the standard menu, etc., provided to general customers, so that the store will be able to provide more attractive menus.

Furthermore, for business operators, by contracting with a store that offers delicious food at cheaper prices, it becomes possible to effectively provide subsidization for meal fees with a lower budget, to employees. Furthermore, the business operator receives a portal application for employees or a Software Development Kit (SDK), etc., from a service provider, etc., who operates the information processing system 100, and, therefore, the business operator is able to provide a portal application for employees with a lower budget, to employees.

Furthermore, the service provider who operates the information processing system 100 analyzes the evaluation results input by the employees and provides information to stores and restaurants, and business operators, etc., that develop menus for food, and, therefore, the service provider can collect a predetermined fee from these stores, etc.

### (Usage Scene 2)

The application for the information processing system 100 executed by the information terminal 102 is not limited to the portal application for employees, but may be an application provided by a store such as a restaurant, for example.

FIG. 14E illustrates an image of an example of a menu screen 1450 of an application provided by the store A. For example, a member of the store A can display a member menu offering a good deal, by selecting a tab 1451 of “member menu” on a menu screen 1450.

As an example, this member menu is a menu desired to be evaluated by users, such as a menu that is newly developed, or a limited menu with a limited number of offers, etc., and this member menu is preferentially offered to a user who has input evaluation information at the previous usage time.

For example, by using an electronic coupon 1452 on the menu screen 1450, a member of the store A can preferentially purchase the member menu lunch B. Furthermore, when the electronic coupon 1452 is used, the information terminal 102 displays an evaluation information input screen 1460 as illustrated in FIG. 14F on the display input unit 306, for example.

In this example, for example, it becomes possible to effectively collect the evaluation comments given by members, who are looking forward to the member menu or the limited menu of the store A.

As described above, according to the embodiments of the present invention, the information processing system 100 that controls the usage rights on food and drinks or services provided at facilities, can provide the facility users with contents that can motivate the facility users to use the facility more often, and collect more reliable evaluation results.

Note that the functional configurations of the information processing system 100 illustrated in FIGS. 4 and 12 are examples, and various functional configurations may be applied to the information processing system 100.

For example, the respective functional configurations of the information processing system 100 may be included in the management server 101. In this case, for example, the management server 101 creates the display screens illustrated in FIGS. 8A to 8F and 14A to 14F, and the information terminal 102 may display the display screen provided by the management server 101 by using a web browser, etc.

Furthermore, at least a part of the functional configurations of the management server 101 may be included in the information terminal. Similarly, at least a part of the functional configurations of the information terminal 102 may be included in the management server 101.

According to one embodiment of the present invention, by the information processing system that controls usage rights relating to food and drinks or services provided at a facility, it is possible to provide facility users with contents that can motivate the facility users to use the facility more often, and to collect more reliable evaluation results.

The information processing system, the terminal apparatus, and the information processing method are not limited to the specific embodiments described in the detailed description, and variations and modifications may be made without departing from the spirit and scope of the present invention.

What is claimed is:

1. An information processing system for controlling one or more usage rights relating to food or a service provided at a facility, the information processing system including an information processing apparatus and a terminal apparatus configured to communicate with the information processing apparatus, the information processing system comprising at least one processor, in communication with at least one memory, executing a process including:
storing information of the one or more usage rights corresponding to the terminal apparatus;
determining whether the terminal apparatus is located in the facility, based on identification information included in a signal output in the facility;
enabling usage of the one or more usage rights relating to the food or the service provided at the facility, among the one or more usage rights corresponding to the terminal apparatus, in response to determining that the terminal apparatus is located in the facility;
displaying, on the terminal apparatus, an input screen requesting input of predetermined information relating to the food or the service corresponding to a first usage right among the one or more usage rights usable in the facility, after the first usage right is used; and
determining whether to validate a usage right other than the first usage right among the one or more usage rights, in the terminal apparatus, according to whether the predetermined information is input to the input screen.

2. The information processing system according to claim 1, wherein the at least one processor invalidates the usage right other than the first usage right among the one or more usage rights corresponding to the terminal apparatus, in the terminal apparatus, in response to determining that the predetermined information is not input to the input screen.

3. The information processing system according to claim 1, wherein the at least one processor validates the usage right other than the first usage right among the one or more usage rights corresponding to the terminal apparatus, in the terminal apparatus, in response to determining that the predetermined information is input to the input screen.

4. The information processing system according to claim 1, wherein the at least one processor validates the usage right other than the first usage right, in the terminal apparatus, in response to determining that the predetermined information is input to the input screen, the usage right other than the first usage right being reported from the information processing apparatus.

5. The information processing system according to claim 1, wherein the at least one processor displays, on a display of the terminal apparatus, one or more valid usage rights among the one or more usage rights corresponding to the terminal apparatus, in a manner such that the one or more valid usage rights can be selected.

6. The information processing system according to claim 1, wherein the at least one processor displays, on a display of the terminal apparatus, one or more invalid usage rights among the one or more usage rights corresponding to the terminal apparatus, in a manner such that the one or more invalid usage rights cannot be selected.

7. The information processing system according to claim 5, wherein the at least one processor displays a selected usage right, which is usable at the facility, on the display of the terminal apparatus in a manner such that a usage process can be performed by the selected usage right in the facility, in response to the selected usage right being selected from among the one or more valid usage rights corresponding to the terminal apparatus.

8. The information processing system according to claim 5, wherein the at least one processor displays a selected usage right, which is not usable at the facility, on the display of the terminal apparatus in a manner such that a usage process cannot be performed by the selected usage right in the facility, in response to the selected usage right being selected from among the one or more valid usage rights corresponding to the terminal apparatus.

9. The information processing system according to claim 1, wherein the at least one processor excludes, from the one or more usage rights corresponding to the terminal apparatus, the first usage right for which the predetermined information is input to the input screen.

10. The information processing system according to claim 1, wherein the predetermined information includes at least one of a comment, an evaluation point, and information relating to good or bad, with respect to the food or the service.

11. The information processing system according to claim 1, wherein the at least one processor collects, from the terminal apparatus, the predetermined information relating to the food or the service input to the input screen, and stores the collected predetermined information.

12. A terminal apparatus for controlling one or more usage rights relating to food or a service provided at a facility, the terminal apparatus comprising a processor, in communication with a memory, executing a process including:
storing information of the one or more usage rights corresponding to the terminal apparatus;
determining whether the terminal apparatus is located in the facility, based on identification information included in a signal output in the facility;
enabling usage of the one or more usage rights relating to the food or the service provided at the facility, among the one or more usage rights corresponding to the terminal apparatus, in response to determining that the terminal apparatus is located in the facility;
displaying, on the terminal apparatus, an input screen requesting input of predetermined information relating to the food or the service corresponding to a first usage right among the one or more usage rights usable in the facility, after the first usage right is used; and
determining whether to validate a usage right other than the first usage right among the one or more usage rights, in the terminal apparatus, according to whether the predetermined information is input to the input screen.

13. A non-transitory computer-readable recording medium storing a program that causes a computer to execute the process executed by the processor included in the terminal apparatus according to claim 12.

14. An information processing method performed in an information processing system for controlling one or more usage rights relating to food or a service provided at a facility, the information processing system including an information processing apparatus and a terminal apparatus configured to communicate with the information processing apparatus, the information processing method comprising:
acquiring, by the terminal apparatus from the information processing apparatus, information of the one or more usage rights corresponding to the terminal apparatus;
acquiring, by the terminal apparatus, signal identification information included in a signal output in the facility, and transmitting, by the terminal apparatus to the information processing apparatus, the acquired signal identification information and terminal identification information identifying the terminal apparatus;
determining, by the information processing apparatus, whether the terminal apparatus is located in the facility, based on the signal identification information and the terminal identification information transmitted from the terminal apparatus;
enabling, by the terminal apparatus, usage of the one or more usage rights relating to the food or the service provided at the facility, among the one or more usage rights corresponding to the terminal apparatus, in response to the terminal apparatus being determined to be located in the facility;
displaying, by the terminal apparatus on the terminal apparatus, an input screen requesting input of predetermined information relating to the food or the service corresponding to a first usage right among the one or more usage rights usable in the facility, after the first usage right is used; and
determining, by the terminal apparatus, whether to validate a usage right other than the first usage right among the one or more usage rights, according to whether the predetermined information is input to the input screen.
